(19) United States
(12) Patent Application Publication
(10) Pub. No.: US 2025/0012644 A1
(43) Pub. Date: Jan. 9, 2025

(54) LOAD SENSOR

(71) Applicant: Panasonic Intellectual Property Management Co., Ltd., Osaka (JP)

(72) Inventors: Shinobu MASUDA, Osaka (JP); Yuta MORIURA, Osaka (JP); Susumu URAGAMI, Kumamoto (JP); Takashi MATSUMOTO, Osaka (JP); Takafumi HAMANO, Fukuoka (JP); Hiroyuki FURUYA, Osaka (JP)

(21) Appl. No.: 18/892,611

(22) Filed: Sep. 23, 2024

Related U.S. Application Data
(63) Continuation of application No. PCT/JP2023/008563, filed on Mar. 7, 2023.

(30) Foreign Application Priority Data
Mar. 24, 2022 (JP) 2022-048596

(51) Int. Cl. G01L 1/14

(52) U.S. Cl. CPC G01L 1/148

(57) ABSTRACT

A load sensor includes: a first electrode having, on an identical face, a first protrusion that is electrically conductive and that has elasticity, and a second protrusion having a higher elastic modulus than the first protrusion; a second electrode opposed to the first electrode with the first protrusion and the second protrusion interposed therebetween; and a dielectric body disposed on an opposing face of the second electrode.

### CROSS REFERENCE TO RELATED APPLICATION

This application is a continuation of International Application No. PCT/JP2023/008563 filed on Mar. 7, 2023, entitled “LOAD SENSOR”, which claims priority under 35 U.S.C. Section 119 of Japanese Patent Application No. 2022-048596 filed on Mar. 24, 2022, entitled “LOAD SENSOR”. The disclosures of the above applications are incorporated herein by reference.

### BACKGROUND OF THE INVENTION

### Field of the Invention

The present invention relates to a load sensor that detects a load applied from outside, based on change in capacitance.

### Description of Related Art

To date, as a Human Machine Interface (HMI), capacitance-type load sensors have been used for various devices such as keyboards and game controllers. For example, the load sensor can be configured to include: a first electrode having a plurality of electrically-conductive protrusions having elasticity; a second electrode opposed to the first electrode with the protrusions interposed therebetween; and a dielectric body disposed on an opposing face of the second electrode. When a load is applied to the first electrode or the second electrode, the protrusions contract in accordance with the load. Accordingly, the contact area between the dielectric body and the protrusions changes, and the distance between the dielectric body and the first electrode decreases. As a result, the capacitance between the first electrode and the second electrode changes. From this change in capacitance, the load is detected.

Japanese Laid-Open Patent Publication No. 2016-118545 describes a load sensor of this type.

In the load sensor having the above configuration, the protrusions are formed from a material having a low elastic modulus. Accordingly, the protrusions smoothly expand and contract in accordance with the load, and a good load sensitivity characteristic can be realized. However, on the other hand, in a material having a low elastic modulus, variation in the elastic modulus is large in general. Therefore, when the protrusions are formed from a material having a low elastic modulus, variation in the sensitivity characteristic is caused between load sensors.

### SUMMARY OF THE INVENTION

A load sensor according to a main aspect of the present invention includes: a first electrode having, on an identical face, a first protrusion that is electrically conductive and that has elasticity, and a second protrusion having a higher elastic modulus than the first protrusion; a second electrode opposed to the first electrode with the first protrusion and the second protrusion interposed therebetween; and a dielectric body disposed on an opposing face of the second electrode.

In the load sensor according to the present aspect, the load is mainly supported by the second protrusion having a high elastic modulus, and thus, regarding the load sensitivity characteristic, deformation of the second protrusion is dominant. On the other hand, since the second protrusion has a high elastic modulus, variation in the elastic modulus for each material is less likely to be caused. Therefore, variation in the sensitivity characteristic between load sensors can be suppressed.

The effects and the significance of the present invention will be further clarified by the description of the embodiment below. However, the embodiment below is merely an example for implementing the present invention. The present invention is not limited to the description of the embodiment below in any way.

### BRIEF DESCRIPTION OF THE DRAWINGS

FIG. 1 is an exploded perspective view schematically showing a configuration of a load sensor according to an embodiment;

FIG. 2A is a side view schematically showing a cross section of the load sensor in an initial state according to the embodiment;

FIG. 2B is a side view schematically showing a cross section of the load sensor in a loaded state according to the embodiment;

FIG. 3A is a graph schematically showing a relationship between load and capacitance according to Comparative Example;

FIG. 3B is a graph schematically showing a relationship between load and capacitance according to the embodiment;

FIG. 4 is a graph schematically showing that the value of capacitance is amplified, according to the embodiment;

FIG. 5 is a graph showing results of a simulation according to the embodiment;

FIG. 6 is a graph showing results of the simulation according to the embodiment;

FIG. 7A and FIG. 7B are each a plan view schematically showing a configuration of a first electrode according to a modification of disposition of first protrusions and second protrusions;

FIG. 8A and FIG. 8B are each a plan view schematically showing a configuration of the first electrode according to a modification of disposition of the first protrusions and the second protrusions;

FIG. 9A and FIG. 9B are each a plan view schematically showing a configuration of the first electrode according to a modification of disposition of the first protrusions and the second protrusions;

FIG. 10A and FIG. 10B are each a side view schematically showing a cross section of the load sensor according to a modification of the shapes of the first protrusion and the second protrusion;

FIG. 11A and FIG. 11B are each a side view schematically showing a cross section of the load sensor according to a modification of the shapes of the first protrusion and the second protrusion;

FIG. 12A and FIG. 12B are each a schematic diagram for describing a formation procedure of the first electrode according to the embodiment;

FIG. 13A and FIG. 13B are each a schematic diagram for describing the formation procedure of the first electrode according to the embodiment;

FIG. 14A and FIG. 14B are each a schematic diagram for describing the formation procedure of the first electrode according to the embodiment;

FIG. 15A and FIG. 15B are each a schematic diagram for describing another formation procedure of the first electrode according to the embodiment;

FIG. 16A and FIG. 16B are each a schematic diagram for describing said another formation procedure of the first electrode according to the embodiment;

FIG. 17A and FIG. 17B are each a schematic diagram for describing said another formation procedure of the first electrode according to the embodiment;

FIG. 18A is a plan view schematically showing a configuration of the first electrode of the load sensor having a configuration in which minimum values are applied, according to examination of dimensions of each component of the load sensor;

FIG. 18B is a plan view schematically showing a configuration of the first electrode of the load sensor having a configuration in which maximum values are applied, according to examination of dimensions of each component of the load sensor;

FIG. 19 is a graph showing results of a simulation performed on the load sensor having a configuration in which minimum values are applied, according to examination of dimensions of each component of the load sensor;

FIG. 20 is a graph showing results of a simulation performed on the load sensor having a configuration in which maximum values are applied, according to examination of dimensions of each component of the load sensor;

FIG. 21A is a cross-sectional view schematically showing a configuration of a load sensor system according to another modification;

FIG. 21B is a plan view schematically showing a configuration of the first electrode of the load sensor system according to said another modification; and

FIG. 22A to FIG. 22E are each a plan view schematically showing a modification of a layout of the load sensor in a load sensor system according to another modification.

It is noted that the drawings are solely for description and do not limit the scope of the present invention in any way.

### DETAILED DESCRIPTION

The present invention is applicable to an input part for performing an input according to an applied load. Specifically, the present invention is applicable to: an input part of an electronic apparatus such as a PC keyboard; an input part of a game controller; a surface layer part for a robot hand to detect an object; an input part for inputting a sound volume, an air volume, a light amount, a temperature, and the like; an input part of a wearable device such as a smartwatch; an input part of a hearable device such as a wireless earphone; an input part of a touch panel; an input part for adjusting an ink amount and the like in an electronic pen; an input part for adjusting a light amount, a color, and the like in a penlight; an input part for adjusting a light amount and the like in lighting clothes; an input part for adjusting a sound volume and the like in a musical instrument; etc.

The embodiment below is a load sensor that is typically provided in the above devices. Such a load sensor is referred to as a “capacitance-type pressure-sensitive sensor element”, a “capacitive pressure detection sensor element”, a “pressure-sensitive switch element”, or the like. The embodiment below is an example of embodiments of the present invention, and the present invention is not limited to the embodiment below in any way.

Hereinafter, an embodiment of the present invention will be described with reference to the drawings. For convenience, X-, Y-, and Z-axes orthogonal to each other are indicated in the drawings. The Z-axis direction is the height direction of a load sensor 1.

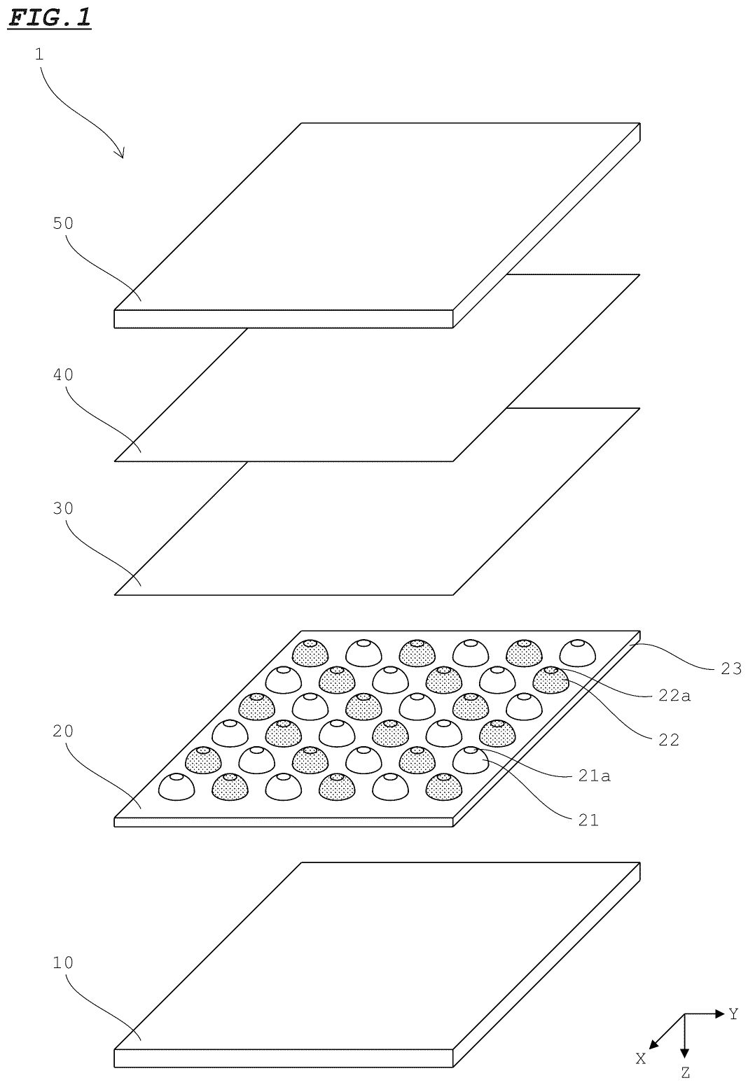

FIG. 1 is an exploded perspective view schematically showing a configuration of the load sensor 1.

The load sensor 1 includes a substrate 10, a first electrode 20, a dielectric body 30, a second electrode 40, and a substrate 50. The external shapes of the substrate 10, the first electrode 20, the dielectric body 30, the second electrode 40, and the substrate 50 have approximately the same square shape in a plan view.

The substrates 10, 50 are each a plate-shaped member having a predetermined thickness. The upper and lower faces of the substrates 10, 50 are parallel to an X-Y plane. The substrate 10 is a support member for setting the first electrode 20, the dielectric body 30, and the second electrode 40. The substrates 10, 50 are each formed from a resin material of at least one type selected from polyethylene terephthalate, polycarbonate, polyimide, and the like, for example.

The first electrode 20 includes a plurality of first protrusions 21, a plurality of second protrusions 22, and a base part 23. The base part 23 is a plate-shaped member, and the first protrusions 21 and the second protrusions 22 are formed so as to protrude from the upper face (the face on the Z-axis negative side) of the base part 23 in the upward direction (the Z-axis negative direction).

The plurality of first protrusions 21 and the plurality of second protrusions 22 are formed so as to be arranged in a grid pattern, on the upper face of the base part 23. That is, on the upper face of the base part 23, the plurality of first protrusions 21 and the plurality of second protrusions 22 are disposed in the Y-axis direction and the X-axis direction so as to be alternately arranged. The interval between the first protrusion 21 and the second protrusion 22 in the Y-axis direction is constant, and the interval between the first protrusion 21 and the second protrusion 22 in the X-axis direction is also constant. In the example shown in FIG. 1, a total of 36, i.e., six in the X-axis direction and six in the Y-axis direction, of the first protrusions 21 and the second protrusions 22 are formed on the upper face of the base part 23. In the present embodiment, the first protrusions 21 and the second protrusions 22 are disposed so as to be adjacent to each other in the X-axis direction and the Y-axis direction.

In the present embodiment, the shape and the size of each first protrusion 21 and each second protrusion 22 are the same with each other. The first protrusion 21 and the second protrusion 22 each have a cross-sectional area that becomes smaller toward the Z-axis negative direction. The first protrusion 21 and the second protrusion 22 each have a hemispherical surface shape. At the upper end of the first protrusion 21, a face 21a parallel to an X-Y plane is formed, and at the upper end of the second protrusion 22, a face 22a parallel to an X-Y plane is formed. The faces 21a, 22a may be omitted.

Each first protrusion 21 and the base part 23 are formed from the same first material and are integrally formed. Each second protrusion 22 is formed from a second material and is formed in a manner integrated with the base part 23. The first protrusion 21 and the base part 23 have elasticity and electric conductivity. The second protrusion 22 has elasticity and has a higher elastic modulus than the first protrusion 21. In FIG. 1, the second protrusion 22 formed from the second material is shown with hatching for convenience.

The first material forming the first protrusion 21 and the base part 23 is a material obtained by mixing an electrically-conductive filler in a first elastic material. The electrically-conductive filler is dispersed in the first elastic material. Accordingly, the first protrusion 21 and the base part 23 have electric conductivity and elasticity. The second material forming the second protrusion 22 is a second elastic material that is insulative and that has a higher elastic modulus than the first material. The elastic modulus of the second protrusion 22 is higher than the elastic modulus of the first protrusion 21. In the present embodiment, no filler is mixed in the second protrusion 22. Therefore, the second protrusion 22 has an insulation property.

The first elastic material and the second elastic material are each formed from a resin material and a rubber material. The resin material that is used for the first elastic material and the second elastic material is, for example, a styrene-based resin, a silicone-based resin (e.g., polydimethylpolysiloxane (PDMS)), an acrylic resin, a rotaxane-based resin, a urethane-based resin, or the like. The rubber material that is used for the first elastic material and the second elastic material is, for example, silicone rubber, isoprene rubber, butadiene rubber, styrene-butadiene rubber, chloroprene rubber, nitrile rubber, polyisobutylene, ethylene propylene rubber, chlorosulfonated polyethylene, acrylic rubber, fluororubber, epichlorohydrin rubber, urethane rubber, natural rubber, or the like. The first elastic material and the second elastic material of the present embodiment are each a silicone rubber. The second elastic material is a silicone rubber having a higher elastic modulus than the silicone rubber of the first elastic material.

The electrically-conductive filler that is mixed in the first elastic material and the second elastic material is, for example, a material of at least one type selected from Au (gold), Ag (silver), Cu (copper), C (carbon), ZnO (zinc oxide), In₂O₃ (indium (III) oxide), and SnO₂ (tin (IV) oxide). The electrically-conductive filler of the present embodiment is C (carbon).

A conductor wire (not shown) for electrically connecting the base part 23 to a device external to the load sensor 1 is set to the base part 23. Accordingly, the first electrode 20 is electrically connected to the external device.

The second electrode 40 is a plate-shaped member opposed to the first electrode 20 with the first protrusions 21 and the second protrusions 22 interposed therebetween. The second electrode 40 is formed from a metal material having electric conductivity. The material of the second electrode 40 is selected from In₂O₃, ZnO, SnO₂, and the like, for example. A conductor wire (not shown) for electrically connecting the second electrode 40 to the device external to the load sensor 1 is set to the second electrode 40.

The dielectric body 30 is disposed on an opposing face (the face on the Z-axis positive side) of the second electrode 40. The dielectric body 30 is formed from a material having an electric insulation property. The material of the dielectric body 30 is selected from, for example, a polypropylene resin, a polyethylene terephthalate resin, a polyimide resin, a polyphenylene sulfide resin, Al₂O₃, Ta₂O₅, and the like. The dielectric body 30 is formed on the lower face (the face on the Z-axis positive side) of the second electrode 40 by insert molding, for example.

During assembly of the load sensor 1, the first electrode 20 is set on the upper face of the substrate 10, and further, a structure composed of the dielectric body 30 and the second electrode 40 is superposed on the upper face of the first electrode 20 such that the dielectric body 30 is opposed to the first electrode 20. Then, the substrate 50 is placed on the second electrode 40, and the periphery of the substrate 50 is set to the substrate 10 by a setting member. Then, the load sensor 1 is completed.

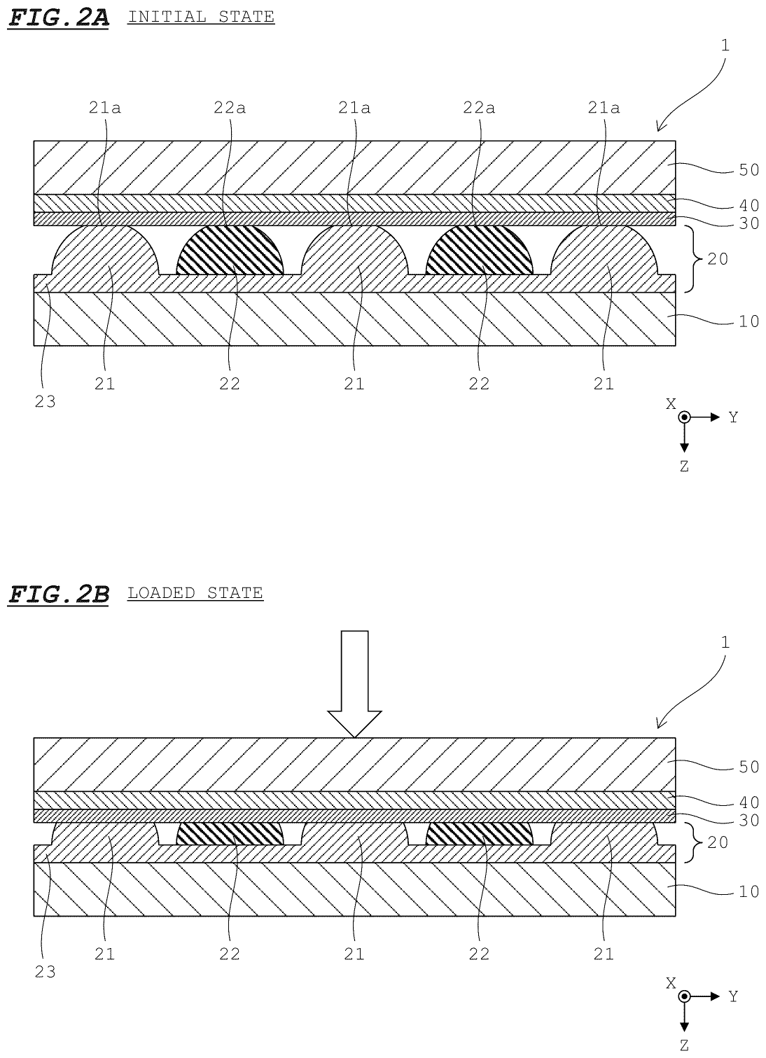

FIG. 2A is a side view schematically showing the load sensor 1 in an initial state (a state where no load is applied). FIG. 2B is a side view schematically showing the load sensor 1 in a loaded state (a state where a load is applied). FIGS. 2A, 2B each show a cross section of the load sensor 1 when cut along a plane parallel to a Y-Z plane passing through the centers of the first protrusions 21 and the second protrusions 22. In FIGS. 2A, 2B, for convenience, the number of the first protrusions 21 and the second protrusions 22 arranged in the Y-axis direction is five.

As shown in FIG. 2A, in the initial state where no load is applied, only the face 21a at the upper end of each first protrusion 21 and the face 22a at the upper end of each second protrusion 22 are in contact with the dielectric body 30.

Then, when a load is applied to the upper face of the substrate 50, the first protrusion 21 and the second protrusion 22 contract in accordance with increase in the load, as shown in FIG. 2B. Accordingly, the contact area between the first protrusion 21 and the dielectric body 30 and the contact area between the second protrusion 22 and the dielectric body 30 increase, and the distance between the dielectric body 30 and the base part 23 becomes short.

When the contact area between the first protrusion 21 and the dielectric body 30 and the distance between the dielectric body 30 and the base part 23 change in association with increase in the load, the capacitance between the second electrode 40 and the first electrode 20 changes in association with the load. This capacitance is proportional to the total contact area between the first protrusions 21 and the dielectric body 30, and is inversely proportional to the thickness of the dielectric body 30 and the distance between the dielectric body 30 and the base part 23. Then, the potential reflecting the change in this capacitance is measured by the external device, whereby the load is calculated.

Meanwhile, in a load sensor, in general, all protrusions formed at the first electrode 20 are formed from a material (a soft material) having a low elastic modulus. Accordingly, the protrusions smoothly expand and contract in accordance with a load, and a good load sensitivity characteristic can be realized. However, on the other hand, in a material having a low elastic modulus, variation in the elastic modulus is large in general. Therefore, when all protrusions are formed from a material having a low elastic modulus, variation is caused in the sensitivity characteristic between load sensors.

In contrast, in the present embodiment, the elastic modulus of the second protrusion 22 is set to be higher than the elastic modulus of the first protrusion 21. The difference in the elastic modulus between the first protrusion 21 and the second protrusion 22 is realized based on the difference in the elastic modulus between the first elastic material forming the first protrusion 21 and the second elastic material forming the second protrusion 22. According to this configuration, the load applied to the load sensor 1 is mainly supported by the second protrusions 22 having a high elastic modulus, and thus, regarding the load sensitivity characteristic, deformation of the second protrusions 22 is dominant. In addition, since the second elastic material has a high elastic modulus, variation in the elastic modulus for each material is less likely to be caused. Accordingly, variation in the sensitivity characteristic between the load sensors 1 can be suppressed.

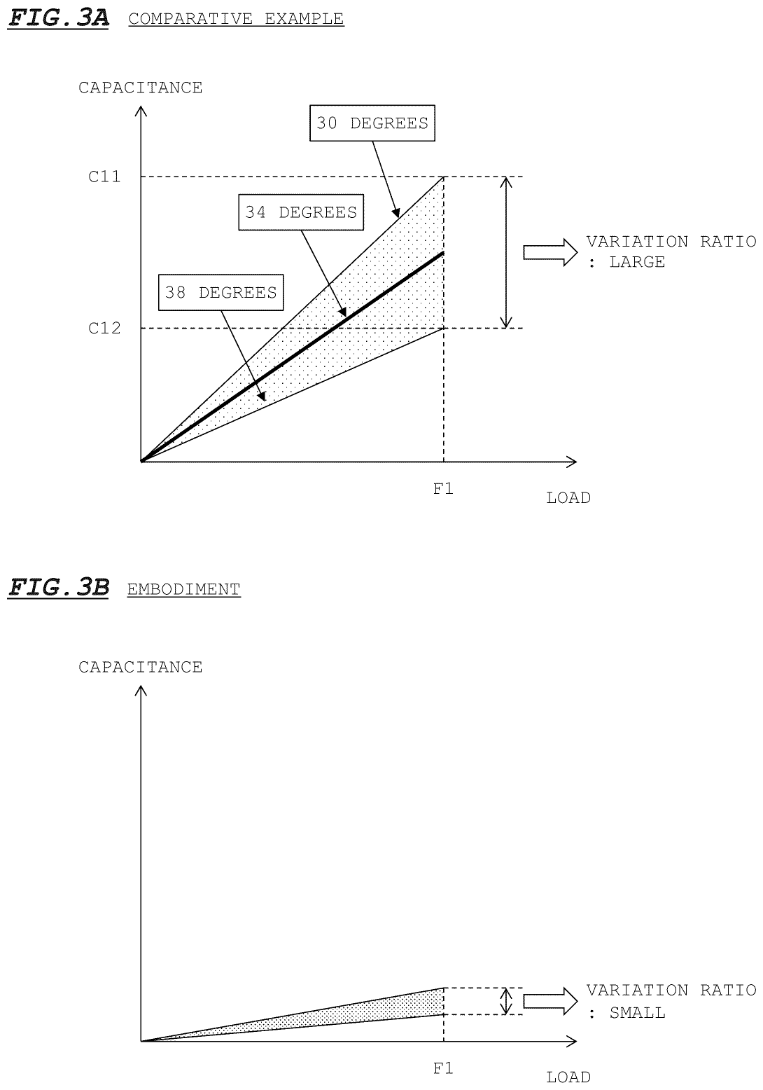

With reference to FIGS. 3A, 3B, a fact that variation in the sensitivity characteristic is suppressed by the configuration of the present embodiment will be described.

FIG. 3A is a graph schematically showing a relationship between load and capacitance according to Comparative Example.

In Comparative Example, all the protrusions of the first electrode 20 are implemented by the first protrusions 21. As described above, the first protrusions 21 have a lower elastic modulus than the second protrusions 22, and are protrusions having an elastic modulus generally used in a load sensor. In this case, as shown in FIG. 3A, for example, the hardness of the first protrusions 21 is 34 degrees in average, and variation in the hardness of about 4 degrees above and below 34 degrees is caused due to manufacturing variation. When the hardness of the first protrusions 21 is at the minimum and at the maximum in the range of this variation, and the capacitances detected with respect to a load F1 (the maximum load in the load detection range) are defined as C11, C12, respectively, a variation ratio indicating the variation in the capacitance between load sensors is calculated by (C11-C12)/{(C11+C12)÷2}.

In general, it is preferable that the capacitance variation ratio is less than 12%, but in the configuration of

Comparative Example, the capacitance variation ratio at the load F1 was significantly larger than the preferable variation ratio condition (12%). When the capacitance variation ratio becomes large like this, load variation acquired in accordance with the capacitance also becomes large. Therefore, even if the same load is applied to a plurality of the load sensors 1, detected loads become different to a large extent between the load sensors.

FIG. 3B is a graph schematically showing a relationship between load and capacitance according to the embodiment.

In the present embodiment, as described above, the first electrode 20 includes a plurality of the first protrusions 21 and a plurality of the second protrusions 22, and the elastic modulus of the second protrusion 22 is set to be higher than the elastic modulus of the first protrusion 21. Accordingly, the load applied to the load sensor 1 is mainly supported by the second protrusions 22 having a high elastic modulus, and thus, the capacitance is less likely to increase with respect to the load, as shown in FIG. 3B. However, on the other hand, since variation in the elastic modulus of the second protrusions 22 is small, the capacitance variation ratio at the load F1 is remarkably suppressed as compared with Comparative Example, and falls within a preferable variation ratio range. Therefore, according to the present embodiment, load variation acquired in accordance with the capacitance also becomes small, and thus, when the same load is applied to a plurality of the load sensors 1, the loads that are detected are made close to each other between the load sensors 1.

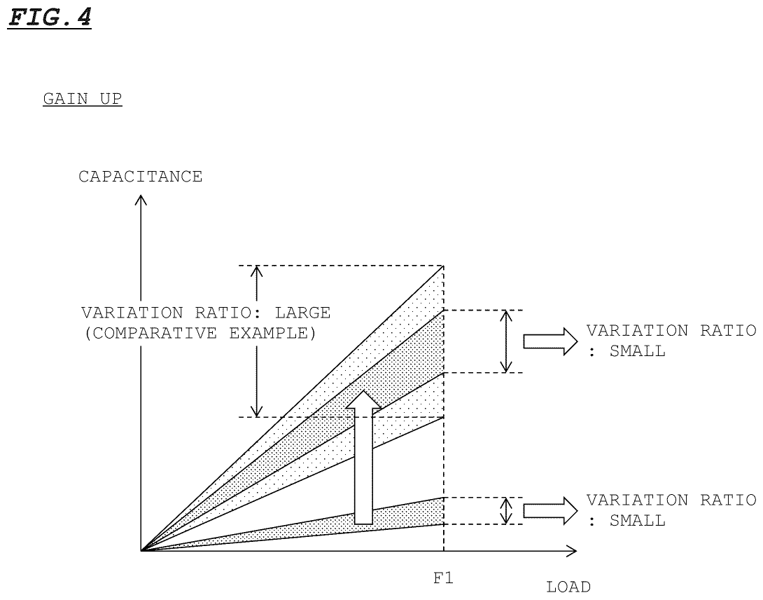

As shown in FIG. 3B, in the present embodiment, the entire hardness obtained with the first protrusions 21 and the second protrusions 22 combined together is high. Therefore, increase in the capacitance with respect to the load is suppressed, and the sensitivity of the load sensor 1 decreases. When such a decrease in the sensitivity is a problem, the detection signal may be amplified (gain up) on the side of the detection circuit connected to the first electrode 20 and the second electrode 40. Accordingly, as shown in FIG. 4, the value of the capacitance obtained in the present embodiment is amplified, and a sufficient sensitivity can be obtained while the capacitance variation ratio is caused to fall within the 12% range.

Instead of the method in which the detection signal is amplified on the side of the detection circuit connected to the first electrode 20 and the second electrode 40 as described above, the dielectric body 30 may be formed from a material having a higher permittivity, and the film thickness of the dielectric body 30 may be made thinner. This increases the capacitance, and accordingly, the sensitivity of the load sensor can be enhanced, as in FIG. 4.

Next, a simulation performed by the inventors will be described.

The inventors performed a simulation with the load sensor 1 as in FIG. 1 set to have dimensions as below.

The pitch between the first protrusion 21 and the second protrusion 22 adjacent to each other was set to 0.215 mm. The height of the first protrusion 21 and the second protrusion 22 was set to 0.05 mm. The thickness of the base part 23 was set to 0.1 mm. The diameter of the face 21a at the upper end of the first protrusion 21 and the face 22a at the upper end of the second protrusion 22 was set to 0.042 mm. The diameter of the lower end of the first protrusion 21 and the lower end of the second protrusion 22 was set to 0.1 mm.

The standard hardness of the first material was set to 34 degrees, and the standard hardness of the second material was set to 90 degrees. The standard hardness is an average hardness of each material, and is an intermediate hardness between the lower limit hardness and the upper limit hardness in the variation range of the hardness of each material. Here, the lower limit hardness and the upper limit hardness of the first material were set to 30 degrees and 38 degrees, respectively, and the lower limit hardness and the upper limit hardness of the second material were set to 88 degrees and 92 degrees, respectively. As the hardness of the first protrusion 21, the lower limit hardness (30 degrees) and the upper limit hardness (38 degrees) of the first material were applied, and as the hardness of the second protrusion 22, the lower limit hardness (88 degrees) and the upper limit hardness (92 degrees) of the second material were applied, whereby four types of load sensors were set.

That is, in the present simulation, a load sensor (referred to as “30 degrees/88 degrees mixed disposition”) in which the first protrusions 21 having a hardness of 30 degrees and the second protrusions 22 having a hardness of 88 degrees were disposed on the first electrode 20; a load sensor (referred to as “38 degrees/88 degrees mixed disposition”) in which the first protrusions 21 having a hardness of 38 degrees and the second protrusions 22 having a hardness of 88 degrees were disposed on the first electrode 20; a load sensor (referred to as “30 degrees/92 degrees mixed disposition”) in which the first protrusions 21 having a hardness of 30 degrees and the second protrusions 22 having a hardness of 92 degrees were disposed on the first electrode 20; and a load sensor (referred to as “38 degrees/92 degrees mixed disposition”) in which the first protrusions 21 having a hardness of 38 degrees and the second protrusions 22 having a hardness of 92 degrees were disposed on the first electrode 20, were set.

For comparison, in the present simulation, a load sensor (referred to as “30 degrees single disposition”) in which only the first protrusions 21 having a hardness of 30 degrees were disposed on the first electrode 20, and a load sensor (referred to as “38 degrees single disposition”) in which only the first protrusions 21 having a hardness of 38 degrees were disposed on the first electrode 20, were set.

The inventors applied a load to each load sensor under the conditions described above, and acquired, through simulation, the capacitance to be detected.

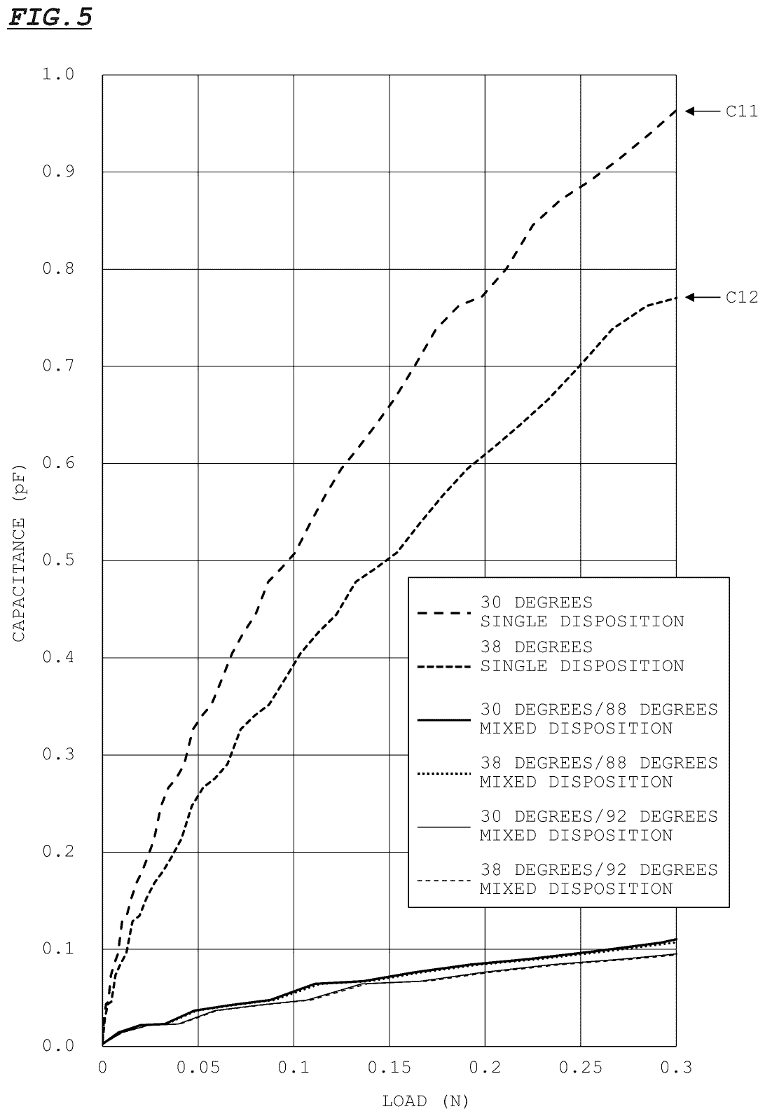

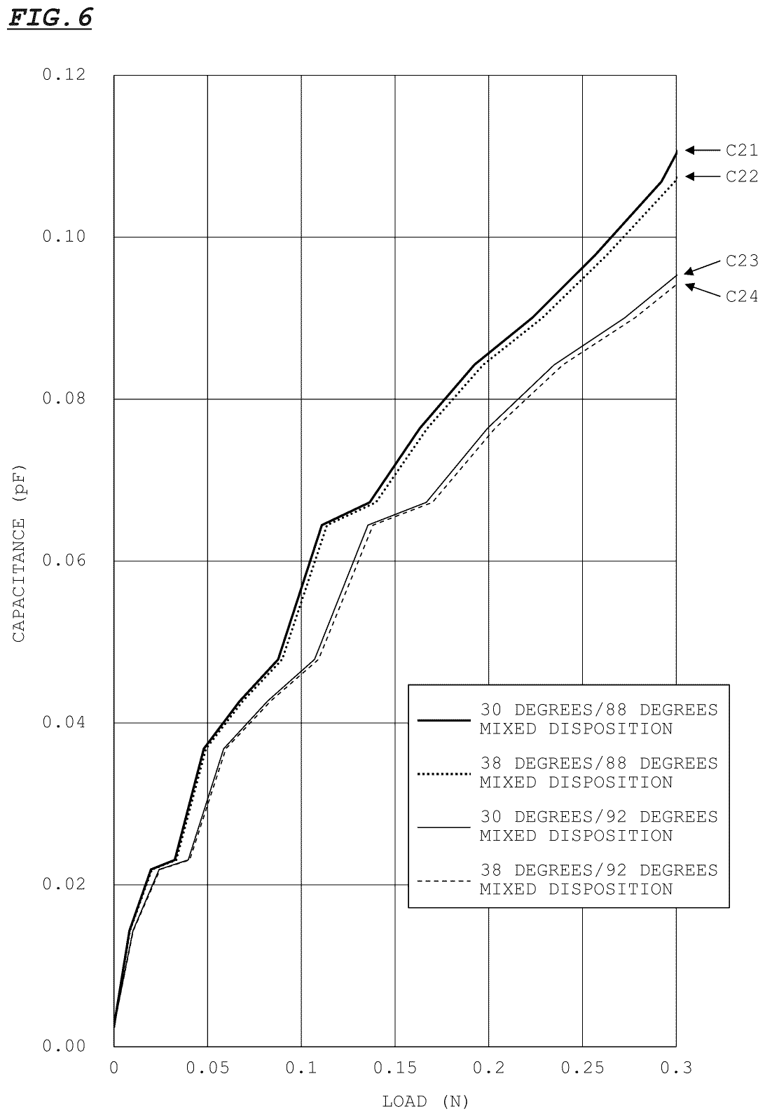

FIG. 5 is a graph showing the results of the present simulation. FIG. 6 is a graph showing the results of the 30 degrees/88 degrees mixed disposition, the 38 degrees/88 degrees mixed disposition, the 30 degrees/92 degrees mixed disposition, and the 38 degrees/92 degrees mixed disposition according to the present simulation. In FIG. 6, the range of the capacitance in the vertical axis is set to 0 (pF) to 0.12 (pF), and the graph in FIG. 5 is enlarged in the vertical axis direction.

As shown in FIG. 5, in the cases of the load sensor (30 degrees single disposition) in which only the first protrusions 21 having a hardness of 30 degrees were disposed, and the load sensor (38 degrees single disposition) in which only the first protrusions 21 having a hardness of 38 degrees were disposed, the capacitances were large with respect to the load, but the difference between the capacitances was large. When the capacitances in the 30 degrees single disposition and the 38 degrees single disposition at a load of 0.3 N were respectively defined as C11, C12, C11=0.964 (pF) and C12=0.770 (pF) were obtained. At this time, the capacitance variation ratio was 22.3 (%). Therefore, it was found that, when only the first protrusions 21 having a variation in the hardness of ±4 degrees with respect to the standard hardness of 34 degrees were disposed, the target 12% was exceeded to a large extent.

On the other hand, in the cases of the load sensors (the 30 degrees/88 degrees mixed disposition, the 38 degrees/88 degrees mixed disposition, the 30 degrees/92 degrees mixed disposition, and the 38 degrees/92 degrees mixed disposition) in which the first protrusions 21 having two types of hardness and the second protrusion 22 having two types of hardness were disposed, the capacitance was small with respect to the load, but the difference in the values of the capacitances between the load sensors was very small.

As shown in FIG. 6, when the capacitances of the 30 degrees/88 degrees mixed disposition, the 38 degrees/88 degrees mixed disposition, the 30 degrees/92 degrees mixed disposition, and the 38 degrees/92 degrees mixed disposition at a load of 0.3 N were respectively defined as C21, C22, C23, and C24, C21=0.110 (pF), C22=0.107 (pF), C23=0.095 (pF), and C24=0.094 (pF) were obtained. At this time, based on the four capacitances, there were six capacitance variation ratios between two load sensors, and in the descending order, 15.8 (%), 14.6 (%), 13.0 (%), 11.8 (%), 2.9 (%), and 1.2 (%) were obtained.

Thus, in the configuration in which the second protrusions 22 were disposed so as to be mixed among the first protrusions 21, the capacitance variation ratio between load sensors was remarkably suppressed as compared with Comparative Example. That is, even if an upper limit hardness and a lower limit hardness, which are the border conditions, in variation were combined as the hardnesses of the first protrusions 21 and the second protrusions 22, the capacitance variation ratio between load sensors was able to be remarkably suppressed as compared with Comparative Example, and was able to be caused to approximately fall within the range of about 12%, which is a preferable range. Therefore, it was able to be confirmed that, when the second protrusions 22 for supporting the load are disposed so as to be mixed among the first protrusions 21, the capacitance variation ratio between load sensors can be effectively suppressed.

### Effects of Embodiment

According to the present embodiment, the following effects are exhibited.

The first electrode 20 has the first protrusion 21 and the second protrusion 22 on an identical face (the upper face of the base part 23). The first protrusion 21 has elasticity and electric conductivity, and the second protrusion 22 has a higher elastic modulus than the first protrusion 21. According to this configuration, a load is mainly supported by the second protrusion 22 having a high elastic modulus, and thus, regarding the load sensitivity characteristic, deformation of the second protrusion 22 is dominant. On the other hand, since the second protrusion 22 has a high elastic modulus, variation in the elastic modulus for each material is less likely to be caused. Therefore, variation in the sensitivity characteristic between the load sensors 1 can be suppressed.

A plurality of the first protrusions 21 and a plurality of the second protrusions 22 are disposed on the first electrode 20. Thus, since the plurality of the first protrusions 21 are disposed, the dynamic range of the load detection can be widened. In addition, since the plurality of the second protrusions 22 are disposed, the load can be easily supported by the second protrusions 22, and accordingly, variation in the sensitivity characteristic can be suppressed.

As shown in FIG. 1, the first protrusions 21 and the second protrusions 22 are alternately disposed on the first electrode 20. Thus, it is preferable that the first protrusions 21 and the second protrusions 22 are distributed as evenly as possible with respect to the detection face to which a load is applied. Accordingly, in the detection face, the load can be detected in good balance by the first protrusions 21, and the load can be supported in good balance by the second protrusions 22.

As shown in FIG. 1 and FIG. 2A, the first protrusion 21 has a cross-sectional area that becomes smaller toward a top portion thereof. According to this configuration, the contact area between the first protrusion 21 and the dielectric body 30 increases in association with increase in the load. Therefore, linearity of the sensitivity characteristic can be enhanced.

As shown in FIG. 1 and FIG. 2A, the first protrusion 21 has a hemispherical surface shape. According to this configuration, the contact area between the first protrusion 21 and the dielectric body 30 smoothly increases in association with increase in the load. Therefore, linearity of the sensitivity characteristic can be enhanced.

The second protrusion 22 is insulative. That is, the second protrusion 22 is composed only of the second elastic material that is insulative, without an electrically-conductive filler mixed in the second protrusion 22. According to this configuration, the elastic deformation characteristic of the second protrusion 22 with respect to the load is dependent only on the second elastic material of the second protrusion 22. Since the second elastic material has a high elastic modulus, variation in the elastic modulus between materials is small. Therefore, occurrence of variation in the elastic deformation characteristic of the second protrusion 22 between the load sensors 1 can be appropriately suppressed, and as a result, variation in the sensitivity characteristic between the load sensors 1 can be effectively suppressed.

The first protrusion 21 is formed from the first elastic material having an electrically-conductive filler mixed therein, and the second protrusion 22 is formed from the second elastic material having a higher elastic modulus than the first elastic material. According to this configuration, the first protrusion 21 having elasticity and electric conductivity and the second protrusion 22 having a high elastic modulus can be easily formed.

The first material (the first elastic material having the electrically-conductive filler mixed therein) forming the first protrusion 21 has a standard hardness of 34 degrees, and the second material (the second elastic material) forming the second protrusion 22 has a standard hardness of 90 degrees. As a material having such hardnesses, silicone rubber can be used, for example. According to this configuration, as was able to be confirmed from the simulation results shown in FIG. 5 and FIG. 6, variation in the sensitivity characteristic can be effectively suppressed.

The first material and the second material may each be a material other than silicone rubber. The first material and the second material may each be another material as long as the detection sensitivity is appropriately obtained and variation in the sensitivity characteristic between the load sensors 1 can be suppressed.

The standard hardness of each of the first material and the second material may be a hardness other than the hardness (34 degrees, 90 degrees) shown in the above simulation. It is preferable that the first material has softness to a certain extent such that the detection sensitivity based on the first protrusion 21 can be appropriately obtained, and it is preferable that the second material has hardness to a certain extent such that the second protrusion 22 can appropriately support the load. From this viewpoint, it is preferable that the standard hardness of the first material is 40 degrees or less, and the standard hardness of the second material is larger than 40 degrees. However, it is preferable that the first material is not too soft so as to allow the shape thereof after elastic deformation to restore, and it is preferable that the second material is not too hard so as not inhibit the detection sensitivity based on the first protrusion 21. From this viewpoint, it is preferable that the lower limit of the standard hardness of the first material is about 10 degrees, and the upper limit of the standard hardness of the second material is about 90 degrees.

### Modification of Disposition of First Protrusion and Second Protrusion

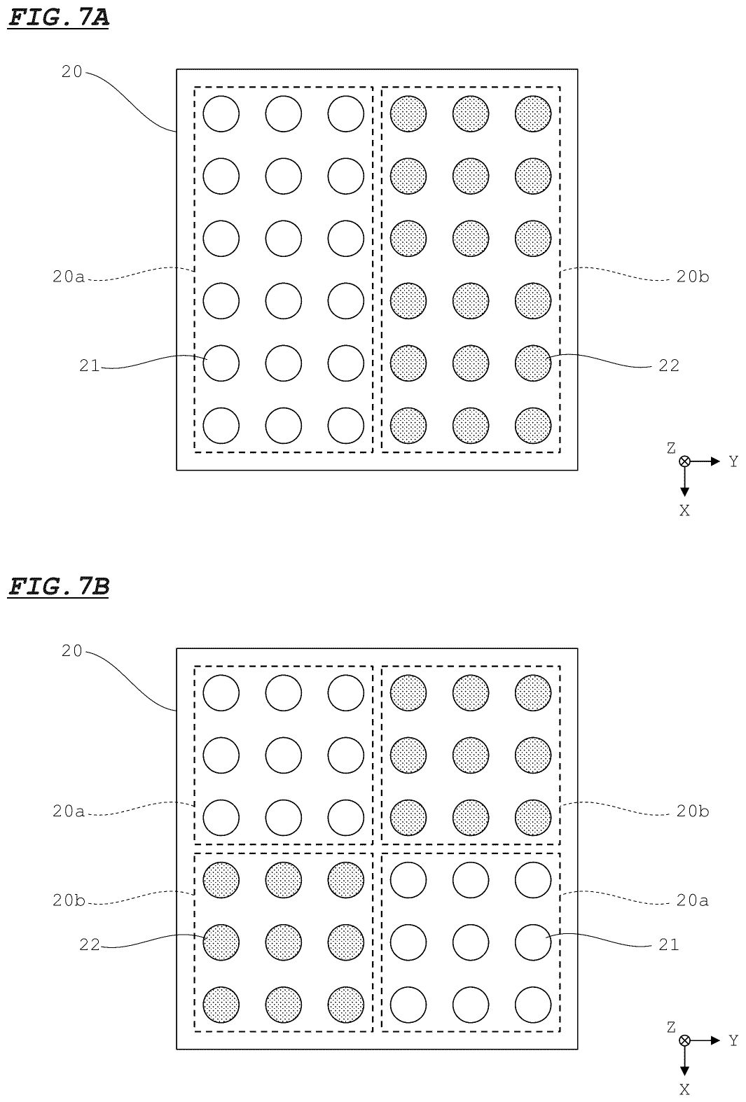

With reference to FIG. 7A to FIG. 9B, a modification of disposition of the first protrusions 21 and the second protrusions 22 will be described. FIG. 7A to FIG. 9B are each a plan view schematically showing a configuration of the first electrode 20 on which the first protrusions 21 and the second protrusions 22 are formed. In each drawing, each second protrusion 22 is shown with hatching, for convenience. The first electrode 20 has a first region 20a in which only a plurality of the first protrusions 21 are disposed, and a second region 20b in which only a plurality of the second protrusions 22 are disposed.

In the example shown in FIG. 7A, the first region 20a and the second region 20b having sizes equal to each other are provided so as to be arranged in the Y-axis direction. According to this example, since the first protrusions 21 and the second protrusions 22 are each disposed in a gathered manner, formation of the first electrode 20 is facilitated. That is, when the first protrusions 21 and the second protrusions 22 have a minute shape and a minute pitch, the first protrusions 21 and the second protrusions 22 are easily formed as compared with the alternate disposition as in FIG. 1.

In the configuration in FIG. 7A, the force supporting the load is different in the Y-axis direction. However, when the load is evenly applied via a plate-shaped member to the entirety of the upper face of the substrate 50 (see FIG. 1), the load can be approximately evenly supported.

In the example shown in FIG. 7B, in quarters corresponding to four corners of the first electrode 20, two first regions 20a and two second regions 20b having sizes equal to each other are provided. In this example, the first electrode 20 includes a plurality of the first regions 20a. Thus, when the first regions 20a are disposed in a plurality of divisions, the load can be detected in good balance at the detection face to which the load is applied. In addition, the first electrode 20 includes a plurality of the second regions 20b. Thus, when the second regions 20b are disposed in a plurality of divisions, the load can be supported in good balance at the detection face to which the load is applied. Further, as compared with the disposition in FIG. 1, since the first protrusions 21 and the second protrusions 22 are each disposed in a gathered manner, formation of the first electrode 20 is facilitated.

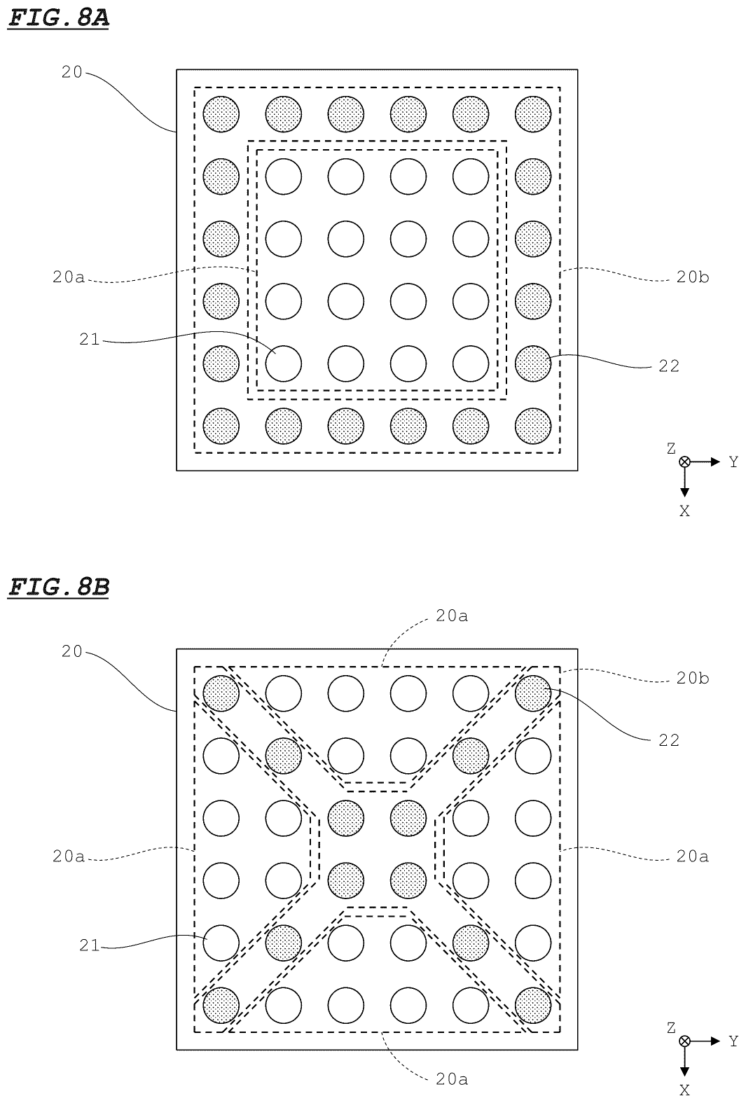

In the example shown in FIG. 8A, one first region 20a is provided at the center of the first electrode 20, and one second region 20b having a frame shape is provided on the outer side of the first region 20a. In this example, since the second region 20b is provided along the outer periphery of the first electrode 20, the load can be detected and supported in good balance at the detection face to which the load is applied. In addition, since the first protrusions 21 and the second protrusions 22 are each disposed in a gathered manner, formation of the first electrode 20 is facilitated. The disposition location of the first region 20a and the second region 20b may be opposite.

In the example shown in FIG. 8B, one second region 20b is provided along the diagonal lines of the first electrode 20, and four first regions 20a are provided near the four sides of the first electrode 20. In this example, since the first electrode 20 includes a plurality of the first regions 20a, the load can be detected in good balance at the detection face to which the load is applied. In addition, since the second region 20b is provided on the diagonal lines of the first electrode 20, the load can be supported in good balance at the detection face to which the load is applied. The disposition location of the first region 20a and the second region 20b may be opposite.

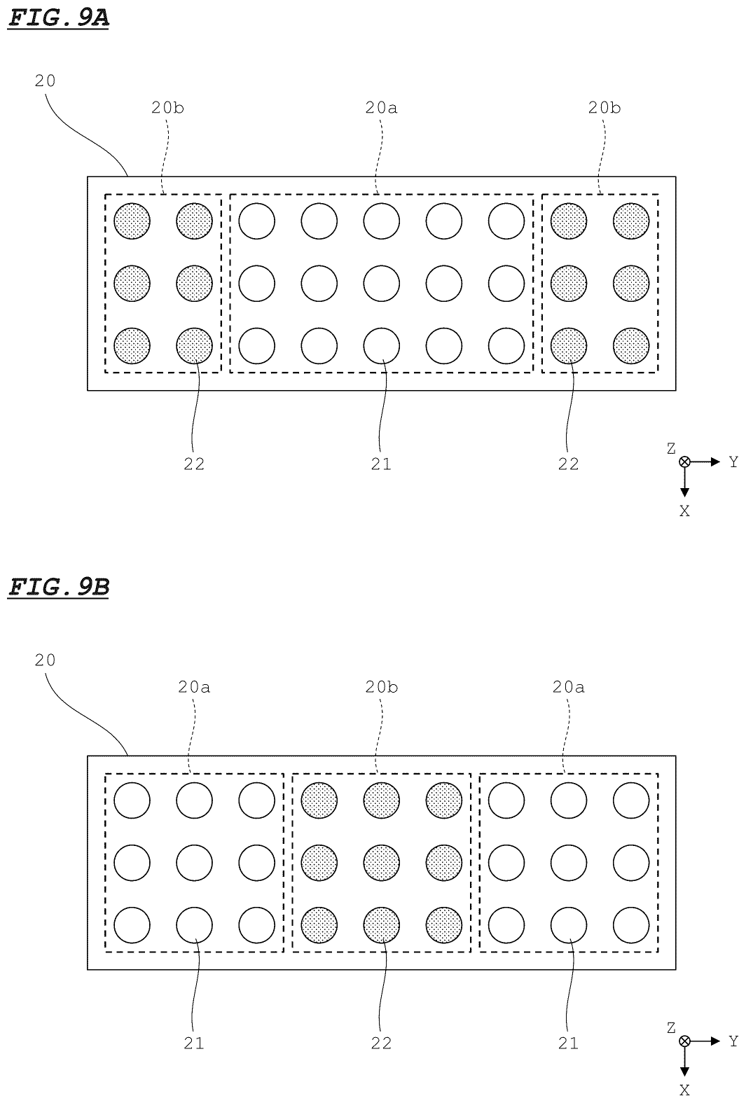

In the example shown in FIG. 9A, the first electrode 20 has a rectangular shape that is long in the Y-axis direction, one first region 20a is provided at the center in the Y-axis direction, and two second regions 20b are provided so as to sandwich the one first region 20a. In this example, since the first electrode 20 includes a plurality of the second regions 20b, the load can be supported in good balance at the detection face to which the load is applied. In addition, since the first protrusions 21 and the second protrusions 22 are each disposed in a gathered manner, formation of the first electrode 20 is facilitated.

In the example shown in FIG. 9B, the first electrode 20 has a rectangular shape that is long in the Y-axis direction, one second region 20b is provided at the center in the Y-axis direction, and two first regions 20a are provided so as to sandwich the one second region 20b. In this example, since the first electrode 20 includes a plurality of the first regions 20a, the load can be detected in good balance at the detection face to which the load is applied. In addition, since the first protrusions 21 and the second protrusions 22 are each disposed in a gathered manner, formation of the first electrode 20 is facilitated.

### Modification of Shape of First Protrusion and Second Protrusion

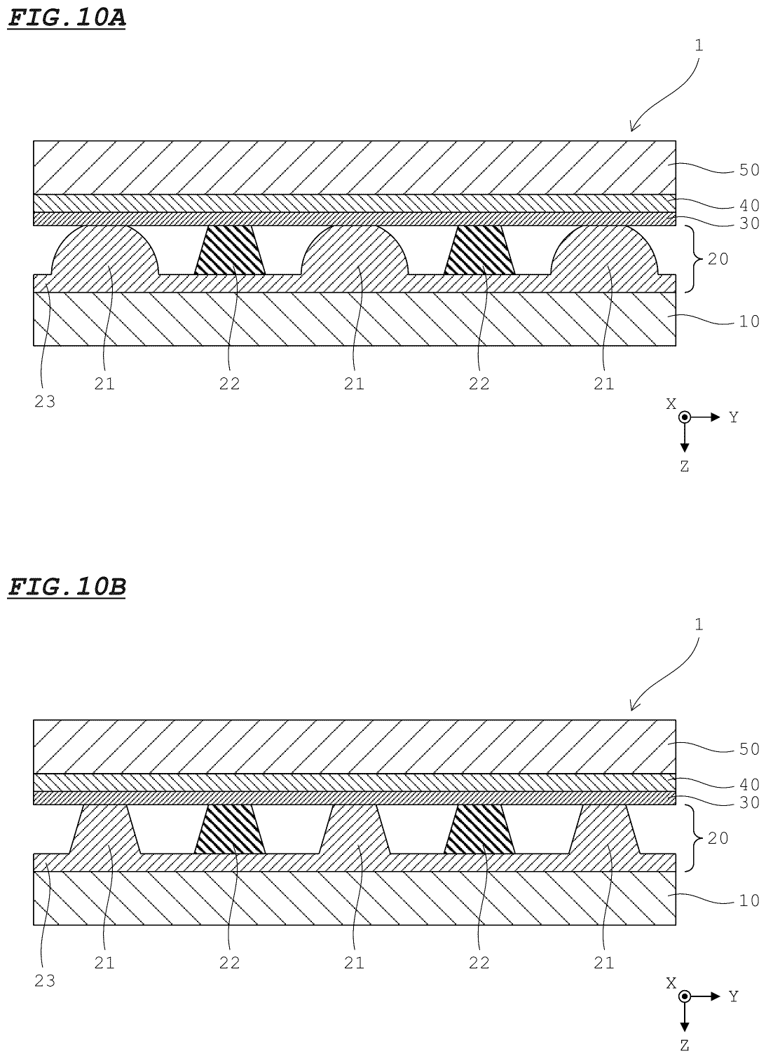

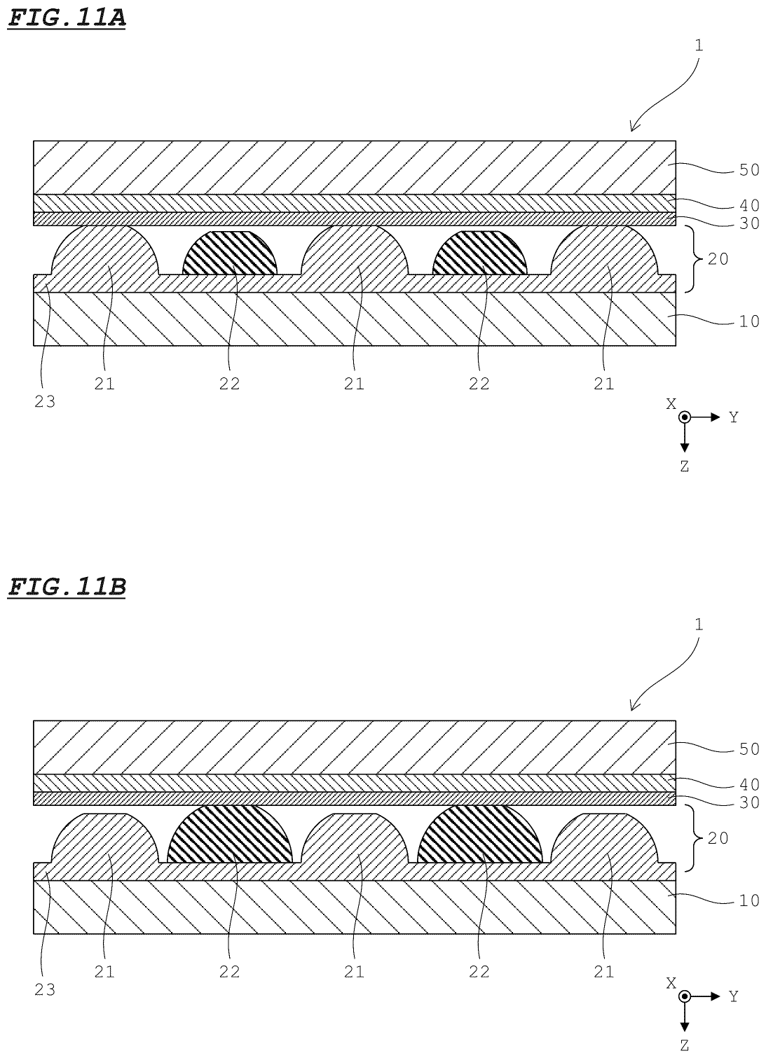

With reference to FIG. 10A to FIG. 11B, modifications of the shapes of the first protrusion 21 and the second protrusion 22 will be described. FIG. 10A to FIG. 11B are each a side view schematically showing a cross section of the load sensor 1 when cut along a plane parallel to a Y-Z plane passing through the centers of the first protrusions 21 and the second protrusions 22.

In the example shown in FIG. 10A, the second protrusion 22 has a cross-sectional area that becomes smaller toward a top portion thereof (an end portion on the Z-axis negative side), and has a truncated cone shape whose central axis extends in the Z-axis direction. In this example as well, since the load is mainly supported by the second protrusions 22 having a high elastic modulus, variation in the sensitivity characteristic between the load sensors 1 can be suppressed.

The second protrusion 22 may have a circular column shape, a cone shape, a polygonal column shape, a pyramid shape, or a truncated pyramid shape. As in the above embodiment, when the second protrusion 22 has an insulation property, the second protrusion 22 may be configured such that the cross-sectional area is constant toward the top portion thereof, or may be configured such that the cross-sectional area becomes larger toward the top portion thereof.

In the example shown in FIG. 10B, both of the first protrusion 21 and the second protrusion 22 have a truncated cone shape. In this example as well, since the first protrusion 21 has a cross-sectional area that becomes smaller toward a top portion thereof, the contact area between the first protrusion 21 and the dielectric body 30 increases in association with increase in the load. Therefore, linearity of the sensitivity characteristic can be enhanced. In addition, since the load is mainly supported by the second protrusions 22 having a high elastic modulus, variation in the sensitivity characteristic between the load sensors 1 can be suppressed.

The first protrusion 21 and the second protrusion 22 may each have a circular column shape, a cone shape, a polygonal column shape, a pyramid shape, or a truncated pyramid shape. However, it is preferable that the first protrusion 21 has a shape whose cross-sectional area becomes smaller toward the upper end thereof.

The heights of the first protrusion 21 and the second protrusion 22 need not necessarily be the same.

In the example shown in FIG. 11A, the height (the length in the Z-axis direction) of the second protrusion 22 is slightly smaller than the height of the first protrusion 21. In this case, immediately after a load is applied, the load is supported by the first protrusions 21, but after the dielectric body 30 has come into contact with the second protrusions 22, the applied load is mainly supported by the second protrusions 22. Therefore, in this case as well, variation in the sensitivity characteristic between the load sensors 1 can be effectively suppressed.

In the example shown in FIG. 11B, the height (the length in the Z-axis direction) of the second protrusion 22 is slightly larger than the height of the first protrusion 21. In this example as well, since the load is mainly supported by the second protrusions 22 having a high elastic modulus, variation in the sensitivity characteristic between the load sensors 1 can be suppressed.

### Formation Procedure of First Electrode

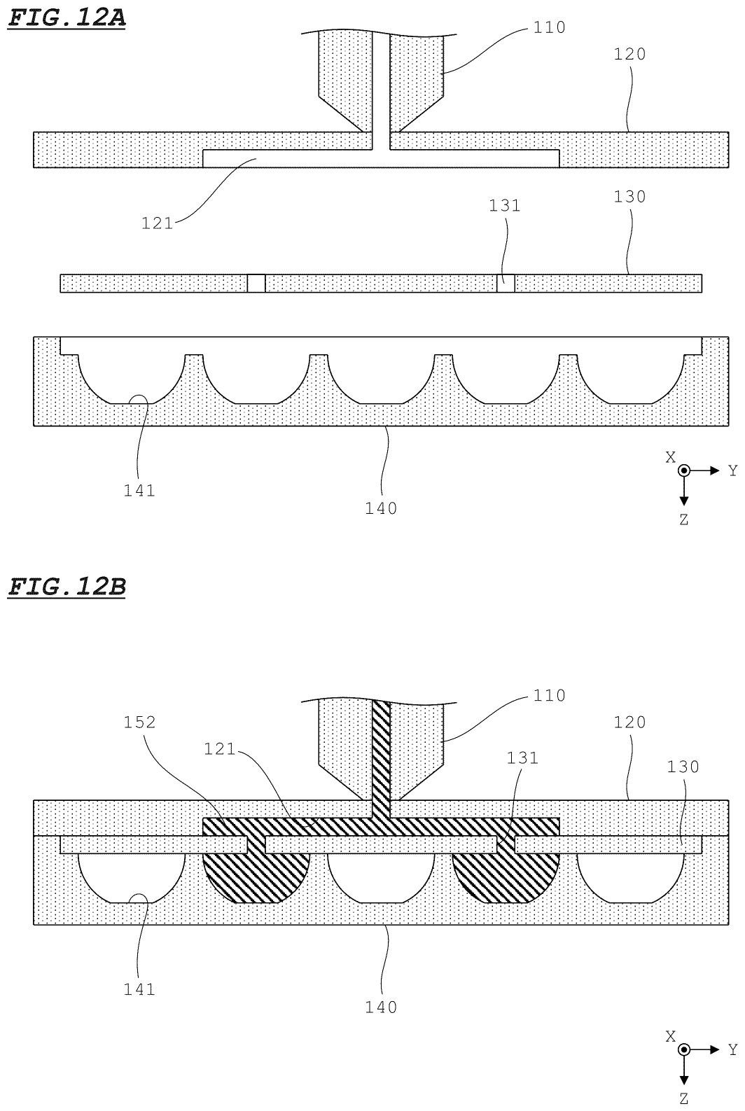

FIG. 12A to FIG. 14B are each a schematic diagram for describing a formation procedure of the first electrode 20. FIG. 12A to FIG. 14B each show a cross section of each component when cut along a plane perpendicular to an X-Y plane.

As shown in FIG. 12A, for formation of the first electrode 20, a material injection part 110, a material guidance part 120, a mask plate 130, and a protrusion formation part 140 are used. In the protrusion formation part 140, a plurality of recesses 141 are formed so as to correspond to the disposition locations of the first protrusions 21 and the second protrusions 22. In the mask plate 130, holes 131 penetrating the mask plate 130 in the up-down direction are formed at locations corresponding to the disposition locations of the second protrusions 22.

As shown in FIG. 12B, the mask plate 130 is fitted in the protrusion formation part 140, and the material injection part 110 and the material guidance part 120 are set at the upper face of the mask plate 130. In this state, from the material injection part 110, a second material 152 serving as the source of the second protrusions 22 is injected. The second material 152 is charged into the recesses 141 corresponding to the second protrusions 22, via a flow path 121 of the material guidance part 120 and the holes 131 in the mask plate 130.

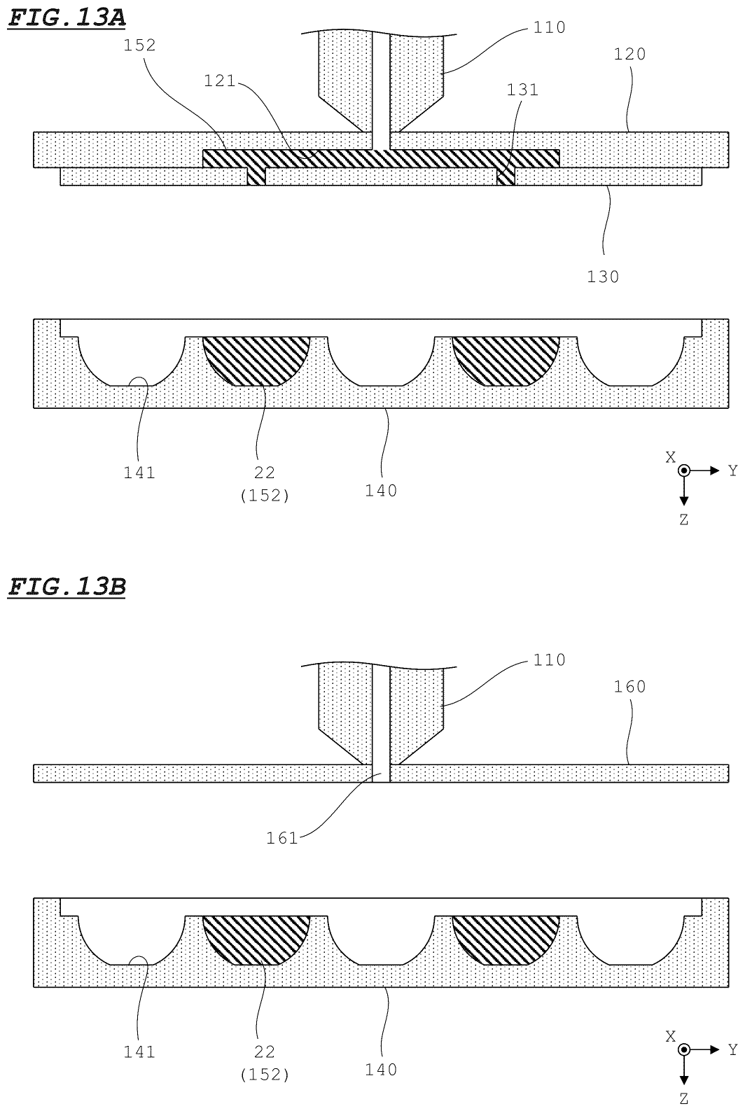

As shown in FIG. 13A, the material injection part 110, the material guidance part 120, and the mask plate 130 are detached from the protrusion formation part 140. Accordingly, the second protrusions 22 are formed.

As shown in FIG. 13B, at the lower end of the material injection part 110, a material guidance part 160 is set instead of the material guidance part 120.

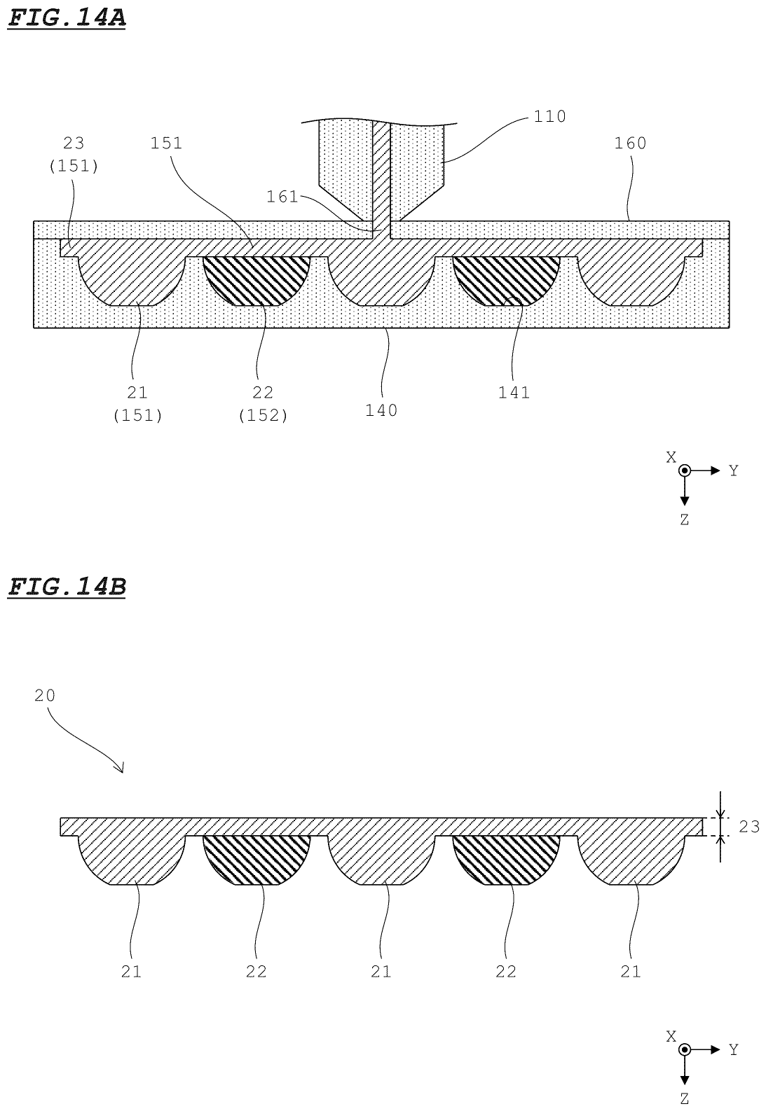

As shown in FIG. 14A, the material injection part 110 and the material guidance part 160 are set at the upper face of the protrusion formation part 140. In this state, from the material injection part 110, a first material 151 serving as the source of the first protrusions 21 and the base part 23 is injected. The first material 151 is charged into the recesses 141 corresponding to the first protrusions 21 via a flow path 161 of the material guidance part 160, and is charged at the location corresponding to the base part 23.

As shown in FIG. 14B, the material injection part 110 and the material guidance part 160 are detached from the protrusion formation part 140, and the first electrode 20 is taken out of the protrusion formation part 140. Thus, the first electrode 20 is completed.

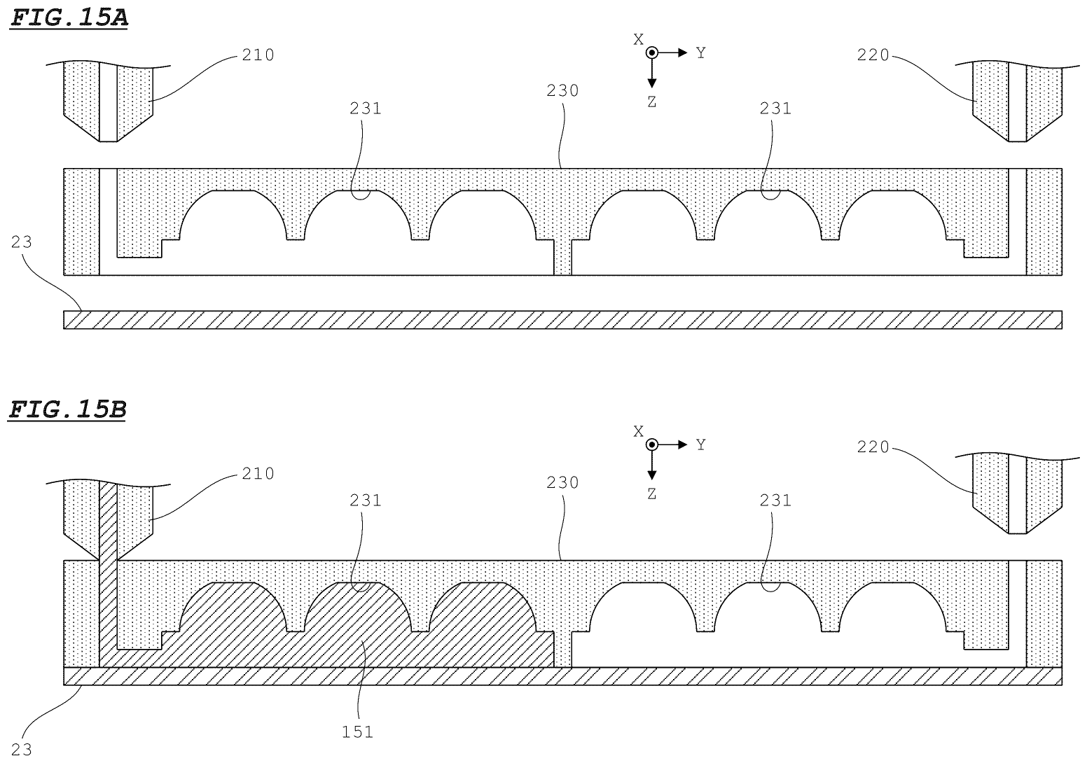

When the first protrusions 21 and the second protrusions 22 are disposed as shown in FIG. 7A to FIG. 9B, i.e., when the first region 20a including a plurality of the first protrusions 21 and the second region 20b including a plurality of the second protrusions 22 are provided, the formation procedure of the first electrode 20 may be a procedure shown in FIG. 15A to FIG. 17B.

FIG. 15A to FIG. 17B are each a schematic diagram for describing another formation procedure of the first electrode 20. FIG. 15A to FIG. 17B each show a cross section of each component when cut along a plane perpendicular to an X-Y plane.

As shown in FIG. 15A, in the formation procedure in this case, material injection parts 210, 220 and a protrusion formation part 230 are used. In the protrusion formation part 230, a plurality of recesses 231 are formed so as to correspond to the disposition locations of the first protrusions 21 and the second protrusions 22. Here, as the base part 23 of the first electrode 20, a stainless plate is used.

As shown in FIG. 15B, the base part 23 is set on the lower face of the protrusion formation part 230, and the material injection part 210 is set on the upper face of the protrusion formation part 230. In this state, from the material injection part 210, the first material 151 serving as the source of the first protrusions 21 is injected. The first material 151 is charged into the recesses 231 corresponding to the first protrusions 21 via a flow path of the protrusion formation part 230.

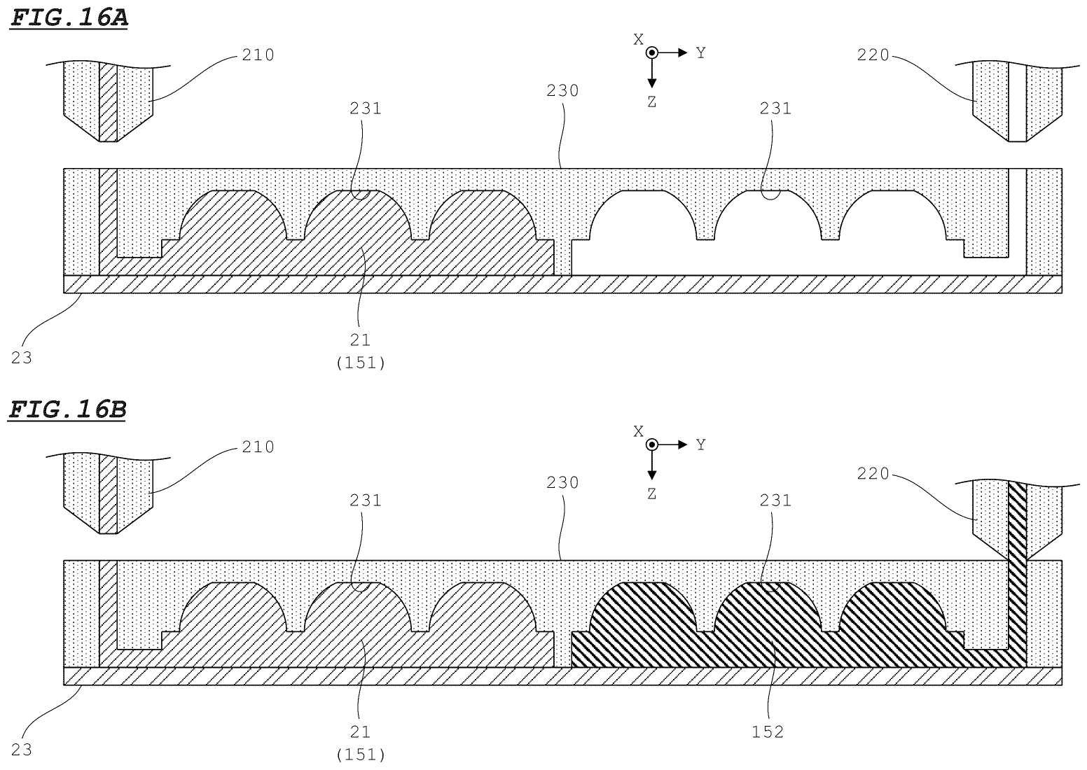

As shown in FIG. 16A, the material injection part 210 is detached from the protrusion formation part 230. Accordingly, the first protrusions 21 are formed.

As shown in FIG. 16B, the material injection part 220 is set on the upper face of the protrusion formation part 230. In this state, from the material injection part 220, the second material 152 serving as the source of the second protrusions 22 is injected. The second material 152 is charged into the recesses 231 corresponding to the second protrusions 22 via a flow path of the protrusion formation part 230.

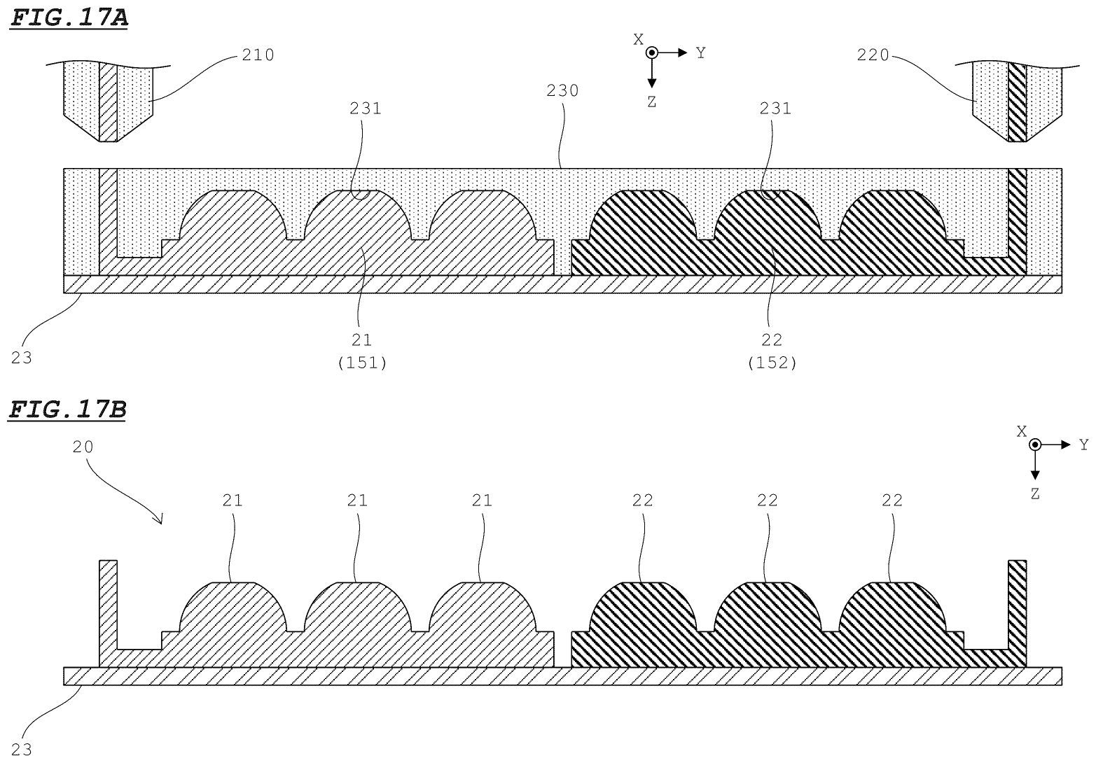

As shown in FIG. 17A, the material injection part 220 is detached from the protrusion formation part 230. Accordingly, the second protrusions 22 are formed.

As shown in FIG. 17B, the protrusion formation part 230 is detached from the base part 23, and the first protrusions 21 and the second protrusions 22 are taken out of the protrusion formation part 230. Thus, the first electrode 20 is completed.

According to the formation procedure shown in FIG. 15A to FIG. 17B, when the first region 20a including a plurality of the first protrusions 21 and the second region 20b including a plurality of the second protrusions 22 are provided, the first electrode 20 can be smoothly formed. For example, the first electrode 20 shown in FIG. 7A to FIG. 9B can be smoothly formed. In addition, even when the size of each component is small as under the conditions of the simulation described with reference to FIG. 5 and FIG. 6, if the formation procedure shown in FIG. 15A to FIG. 17B is used for a layout in which a plurality of protrusions of the same type are adjacent to each other in the X-axis direction or the Y-axis direction as in FIG. 7A to FIG. 9B, the first electrode 20 can be smoothly formed.

### Examination of Dimensions of Each Component of Load Sensor

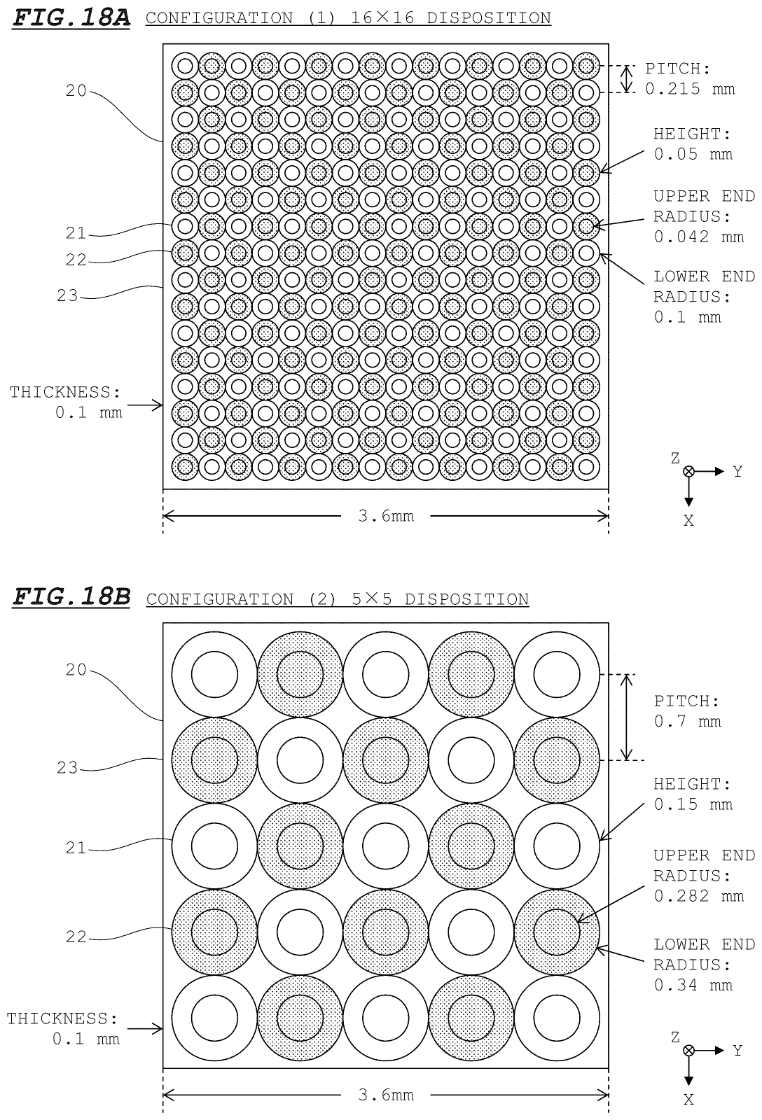

With respect to the load sensor 1 in which the first protrusion 21 and the second protrusion 22 had the shapes in FIG. 10B, the inventors examined a preferable range of the dimensions of each component through a simulation. In this simulation, the dimensions of each component were set as in FIGS. 18A, 18B. FIGS. 18A, 18B are each a plan view schematically showing a configuration of the first electrode 20 of the load sensor 1.

In the present simulation as well, as in the simulation shown in FIGS. 5, 6, the 30 degrees/88 degrees mixed disposition, the 38 degrees/88 degrees mixed disposition, the 30 degrees/92 degrees mixed disposition, and the 38 degrees/92 degrees mixed disposition were set. For comparison, in the present simulation as well, the 30 degrees single disposition and the 38 degrees single disposition were set.

Under the conditions as above, a load was applied to two load sensors respectively having the configurations in FIGS. 18A, 18B, and capacitances to be detected were obtained through simulation. Here, as a parameter for evaluating the difference (variation in the capacitance) between the two types of capacitance, a capacitance change ratio calculated by (C1-C2)/C1 was acquired. C1 and C2 are respective two capacitances to be compared at a load of 0.9 N, and C1>C2 is satisfied.

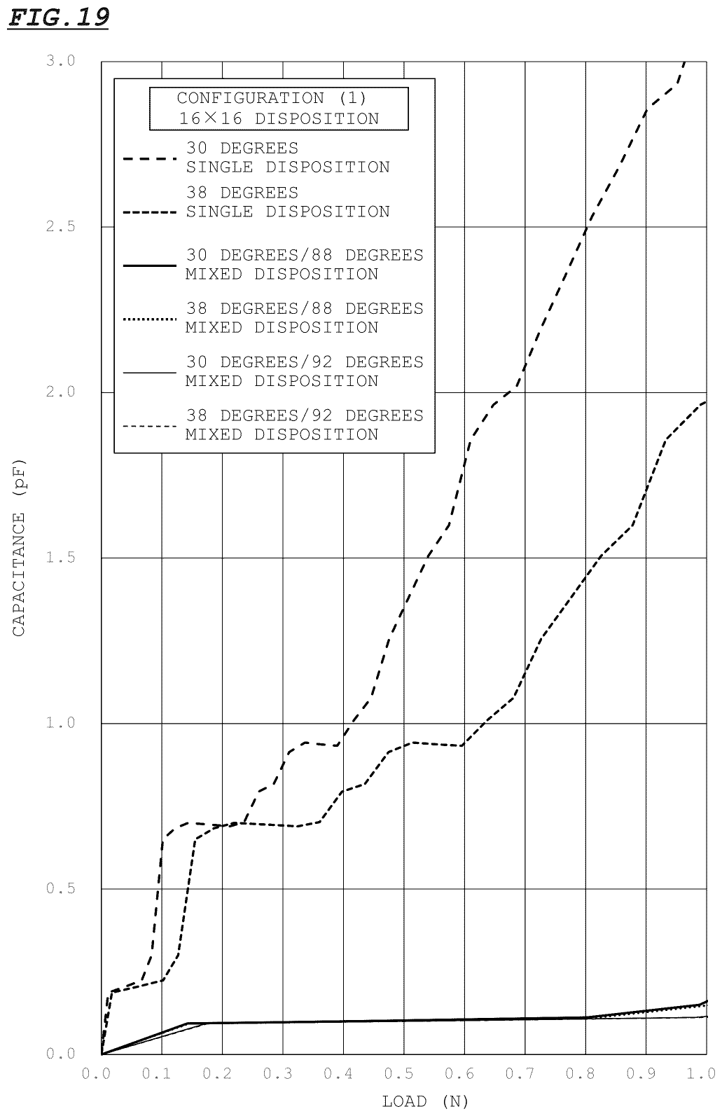

FIG. 19 is a graph showing the results of the present simulation performed on the load sensor having the configuration in FIG. 18A.

In the cases (Comparative Example) of a load sensor (the 30 degrees single disposition) in which only the first protrusions 21 having a hardness of 30 degrees were disposed and a load sensor (the 38 degrees single disposition) in which only the first protrusions 21 having a hardness of 38 degrees were disposed, the difference between both capacitances was large as shown in FIG. 19. In this case, the capacitance change ratio at a load of 0.9 N was 53.9 (%).

On the other hand, in the cases of load sensors (the 30 degrees/88 degrees mixed disposition, the 38 degrees/88 degrees mixed disposition, the 30 degrees/92 degrees mixed disposition, and the 38 degrees/92 degrees mixed disposition) corresponding to dispositions including the first protrusions 21 having two types of hardness and the second protrusions 22 having two types of hardness, the graphs showing the capacitances in all of the load sensors were concentrated in approximately the same region, as shown in FIG. 19. In this case, the capacitance change ratio in each combination of two out of the four capacitances at a load of 0.9 N was less than 0.01 (%).

Thus, in the configuration in FIG. 18A, the capacitance change ratio between load sensors was remarkably suppressed as compared with Comparative Example.

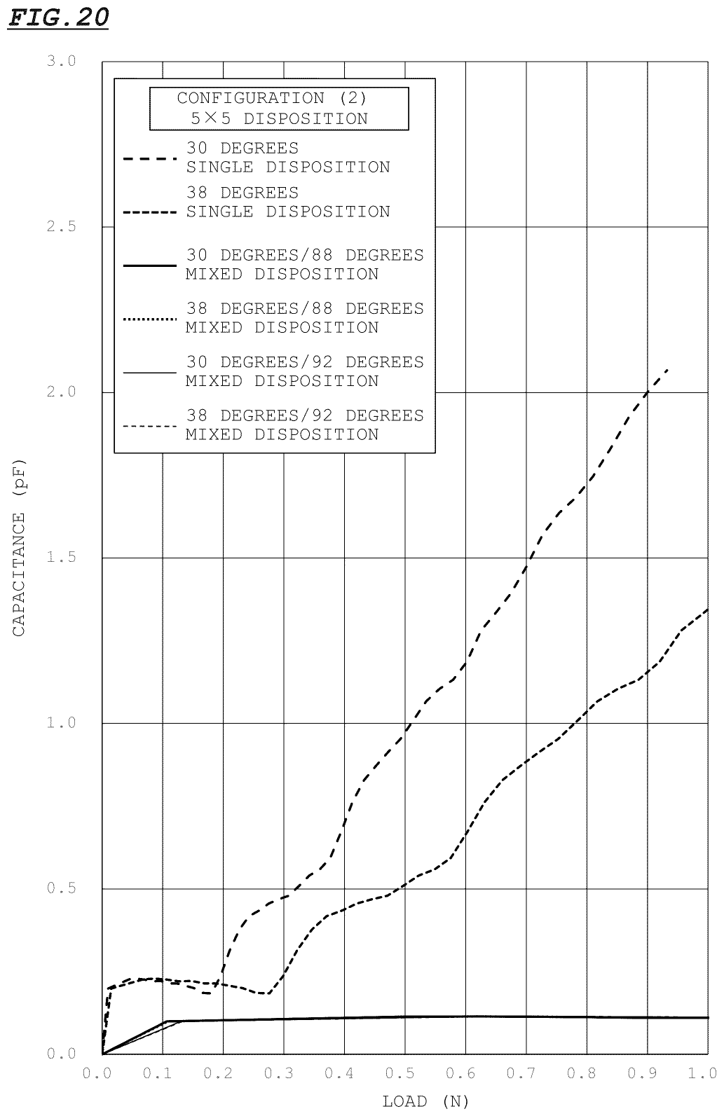

FIG. 20 is a graph showing the results of the present simulation performed on the load sensor having the configuration in FIG. 18B.

In the cases (Comparative Example) of a load sensor (the 30 degrees single disposition) in which only the first protrusions 21 having a hardness of 30 degrees were disposed, and a load sensor (the 38 degrees single disposition) in which only the first protrusions 21 having a hardness of 38 degrees were disposed, the difference between both capacitances was large, as shown in FIG. 20. In this case, the capacitance change ratio at a load of 0.9 N was 74.2 (%).

On the other hand, in the cases of load sensors (the 30 degrees/88 degrees mixed disposition, the 38 degrees/88 degrees mixed disposition, the 30 degrees/92 degrees mixed disposition, and the 38 degrees/92 degrees mixed disposition) corresponding to dispositions including the first protrusions 21 having two types of hardness and the second protrusions 22 having two types of hardness, the graphs showing the capacitances in all of the load sensors were concentrated in approximately the same region, as shown in FIG. 20. In this case, the capacitance change ratio in each combination of two out of the four capacitances at a load of 0.9 N was less than 0.01 (%).

Thus, in the configuration in FIG. 18B as well, the capacitance change ratio between load sensors was remarkably suppressed as compared with Comparative Example.

As described above, in both of the configuration in FIG. 18A and the configuration in FIG. 18B, the capacitance change ratio (variation) was remarkably suppressed. Therefore, at least in a range where the dimensions set in these configurations are used as the lower limit and the upper limit, variation in the capacitance can be remarkably suppressed.

From this, it can be said that the pitch between the first protrusion 21 and the second protrusion 22 adjacent to each other is preferably 0.215 mm or more and 0.7 mm or less, and that the height of the first protrusion 21 and the second protrusion 22 is preferably 0.05 mm or more and 0.15 mm or less. In addition, it can be said that the radius of the face 21a at the upper end of the first protrusion 21 and the face 22a at the upper end of the second protrusion 22 is preferably 0.042 mm or more and 0.282 mm or less, and that the radius of the lower end of the first protrusion 21 and the lower end of the second protrusion 22 is preferably 0.1 mm or more and 0.34 mm or less. When the dimensions of the first protrusion 21 and the second protrusion 22 are set to be at least in this range, variation in the sensitivity characteristic between the load sensors 1 can be effectively suppressed.

### Other Modifications

The configuration of the load sensor 1 can be modified in various ways other than the configurations shown in the above embodiment.

In the above embodiment, the first protrusion 21 is integrally formed with the base part 23, but similar to the second protrusion 22 in the above embodiment, the first protrusion 21 may be formed as a body separate from the base part 23, and the first protrusion 21 and the base part 23 may be integrated. In addition, the first protrusion 21 and the second protrusion 22 may be superposed on a metal electrode to be integrated as shown in FIG. 17B, whereby the first electrode 20 may be formed.

In the above embodiment, the first electrode 20 includes a plurality of the first protrusions 21 and a plurality of the second protrusions 22. However, the number of the first protrusions 21 provided to the first electrode 20 may be one, and the number of the second protrusions 22 provided to the first electrode 20 may be one.

In the above embodiment, the number of the first protrusions 21 and the number of the second protrusions 22 are the same, but need not necessarily be the same. In order to enhance the sensitivity of the load sensor 1, it is preferable that the number of the first protrusions 21 is larger than the number of the second protrusions 22.

In the above embodiment, the first protrusion 21 and the second protrusion 22 may each be a ridge that is long in the X-axis direction or the Y-axis direction. The ridge in this case may have a triangular column shape or may have a semicircular column shape.

In the above embodiment, the first protrusions 21 and the second protrusions 22 are disposed on the upper face of the base part 23 so as to be arranged at a constant interval in the X-axis direction and the Y-axis direction. However, the disposition interval between the first protrusion 21 and the second protrusion 22 need not necessarily be constant.

In the above embodiment, the first elastic material forming the first protrusion 21 and the second elastic material forming the second protrusion 22 are each silicone rubber. However, the first elastic material and the second elastic material may be different from each other. As long as the elastic modulus of the second protrusion 22 (the second elastic material) is higher than the elastic modulus of the first protrusion 21 in which the filler is dispersed in the first elastic material, each of the first elastic material and the second elastic material may be changed to a material different from that in the above embodiment.

In the above embodiment, the second material forming the second protrusion 22 is composed only of the second elastic material. That is, in the second elastic material, the electrically-conductive filler is not mixed, and the second protrusion 22 has an insulation property. However, not limited thereto, the second protrusion 22 may be formed from the second elastic material having the electrically-conductive filler mixed therein, to have electric conductivity. Accordingly, change in the contact area between the second protrusion 22 and the dielectric body 30 during application of a load contributes to change in the capacitance between the first electrode 20 and the second electrode 40.

However, when the filler is mixed in the second protrusion 22, variation may be caused in the deformation characteristic of the second protrusion 22. In addition, due to the mixing of the filler, the hardness of the second protrusion 22 increases and the sensitivity of the capacitance decreases. Therefore, from the viewpoint of the deformation characteristic and the sensitivity characteristic, it is preferable that the filler is not mixed in the second protrusion 22. Therefore, it can be said that the second protrusion 22 is preferably composed only of the second elastic material as in the above embodiment.

In addition to the above, various modifications can be made as appropriate to the embodiment of the present invention without departing from the scope of the technical idea defined by the claims.

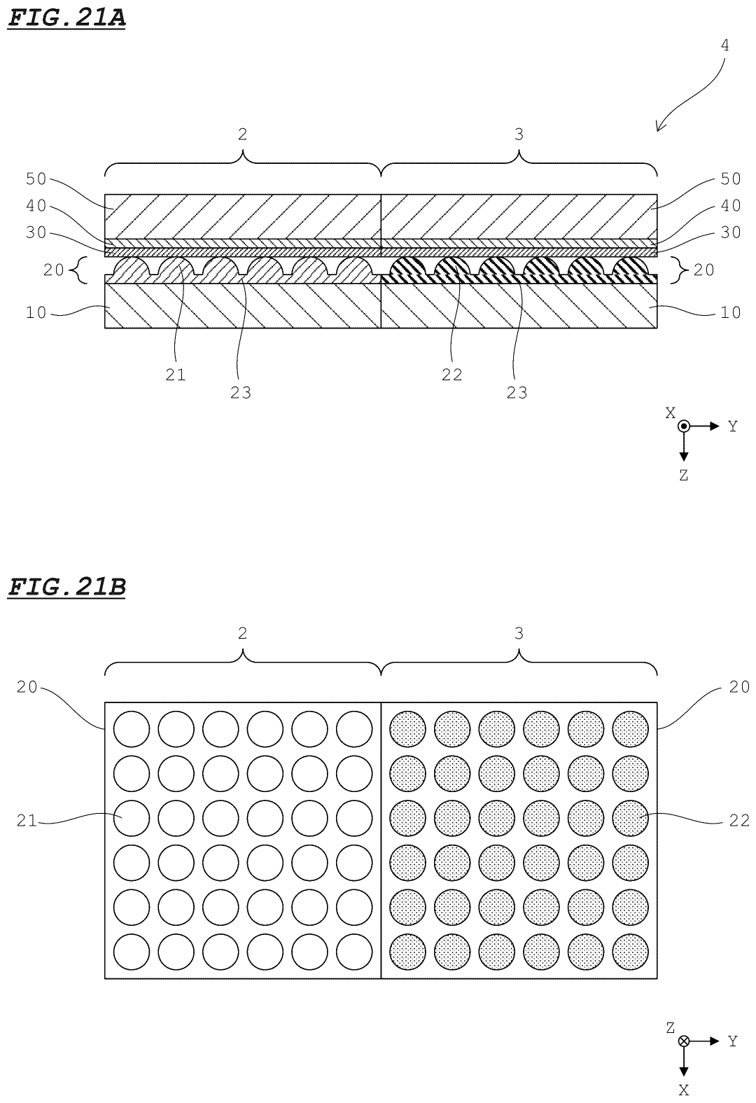

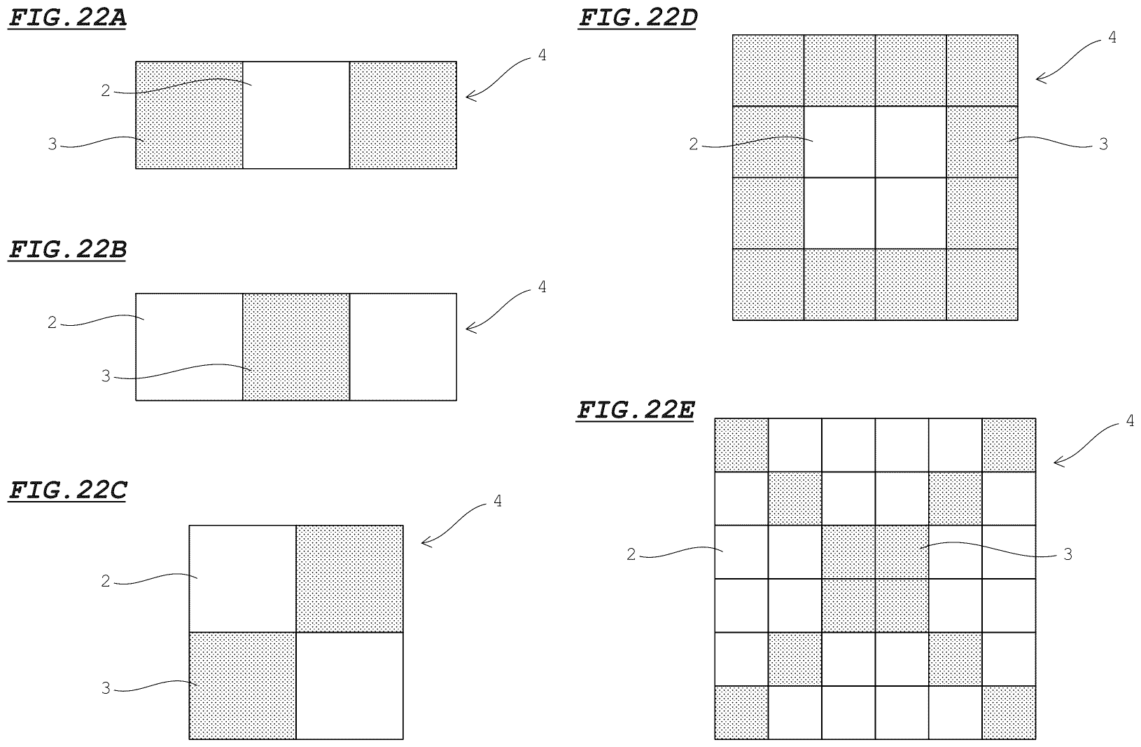

When a load sensor system is configured by disposing a plurality of load sensors in a planar direction, configurations shown in FIG. 21A to FIG. 22E may be used.

FIG. 21A is a cross-sectional view schematically showing a configuration of a load sensor system 4. FIG. 21B is a plan view schematically showing a configuration of the first electrode 20 of the load sensor system 4.

As shown in FIG. 21A, the load sensor system 4 includes load sensors 2, 3 adjacent to each other in the Y-axis direction. As shown in FIG. 21B, all of the protrusions of the first electrode 20 of the load sensor 2 are the first protrusions 21. All of the protrusions of the first electrode 20 of the load sensor 3 are the second protrusions 22.

When a load is applied across the upper face of the substrate 50 of the load sensor 2 and the upper face of the substrate 50 of the load sensor 3, an external device connected to the load sensors 2, 3 adds the load calculated by the load sensor 2 and the load calculated by the load sensor 3, to detect the load applied to the upper face (the upper faces of the load sensors 2, 3) of the load sensor system 4.

In the load sensor system 4, the load applied to the upper face (the upper faces of the load sensors 2, 3) of the load sensor system 4 is mainly supported by the load sensor 3 including the second protrusions 22 having a high elastic modulus. Therefore, regarding the load sensitivity characteristic, deformation of the load sensor 3 is dominant. In addition, since the second protrusions 22 have a high elastic modulus, variation in the elastic modulus for each material is less likely to be caused. Therefore, variation in the sensitivity characteristic between the load sensors 2, 3 in one load sensor system 4 can be suppressed.

FIGS. 21A, 21B each show an example in which, in the load sensor system 4, two load sensors 2, 3 are disposed so as to be arranged one by one in the sideways direction. However, the layout of the load sensors 2, 3 is not limited thereto, and, for example, a layout shown in FIGS. 22A to 22E may be adopted.

FIGS. 22A to 22E are each a plan view schematically showing a modification of the layout of the load sensors 2, 3 in the load sensor system 4. In each drawing, the load sensor 3 is shown with hatching for convenience.

In the example shown in FIG. 22A, the load sensors 3 are disposed to the left and right of the load sensor 2 so as to sandwich one load sensor 2. In the example shown in FIG. 22B, the load sensors 2 are disposed to the left and right of the load sensor 3 so as to sandwich one load sensor 3. In these examples, the load can be supported in good balance at the upper face of the load sensor system 4.

In the example shown in FIG. 22C, the load sensors 2, 3 are disposed so as be arranged in a grid pattern in the X-axis direction and the Y-axis direction, so as to be adjacent to each other. In this example, since the load sensors 2, 3 are disposed in a grid pattern so as to be adjacent to each other, the load can be supported in good balance at the upper face of the load sensor system 4, and the applied load can be detected in good balance.

In the example shown in FIG. 22D, a plurality of the load sensors 2 are disposed at the center, and a plurality of the load sensors 3 are disposed in a frame shape on the outer side of the load sensors 2. In this example as well, the load can be supported in good balance at the upper face of the load sensor system 4, and the applied load can be detected in good balance. The disposition locations of the load sensors 2, 3 may be opposite.

In the example shown in FIG. 22E, a plurality of the load sensors 3 are disposed along the diagonal lines of the load sensor system 4, and a plurality of the load sensors 2 are disposed near each of the four sides of the load sensor system 4. In this example as well, the load can be supported in good balance at the upper face of the load sensor system 4, and the applied load can be detected in good balance. The disposition locations of the load sensors 2, 3 may be opposite.

What is claimed is:

1. A load sensor comprising:
a first electrode having, on an identical face, a first protrusion that is electrically conductive and that has elasticity, and a second protrusion having a higher elastic modulus than the first protrusion;
a second electrode opposed to the first electrode with the first protrusion and the second protrusion interposed therebetween; and
a dielectric body disposed on an opposing face of the second electrode.

2. The load sensor according to claim 1, wherein
a plurality of the first protrusions and a plurality of the second protrusions are disposed on the first electrode.

3. The load sensor according to claim 2, wherein
the first electrode has a first region in which only a plurality of the first protrusions are disposed and a second region in which only a plurality of the second protrusions are disposed.

4. The load sensor according to claim 3, wherein
the first electrode comprises a plurality of the first regions.

5. The load sensor according to claim 3, wherein
the first electrode comprises a plurality of the second regions.

6. The load sensor according to claim 2, wherein
the first protrusions and the second protrusions are alternately disposed on the first electrode.

7. The load sensor according to claim 1, wherein
the first protrusion and the second protrusion have a same height with each other.

8. The load sensor according to claim 1, wherein
the first protrusion has a cross-sectional area that becomes smaller toward a top portion thereof.

9. The load sensor according to claim 8, wherein
the first protrusion has a hemispherical surface shape.

10. The load sensor according to claim 1, wherein
the second protrusion has a cross-sectional area that becomes smaller toward a top portion thereof.

11. The load sensor according to claim 10, wherein
the second protrusion has a hemispherical surface shape.

12. The load sensor according to claim 1, wherein
the first protrusion and the second protrusion have a same shape with each other.

13. The load sensor according to claim 1, wherein
the second protrusion is insulative.

14. The load sensor according to claim 1, wherein
the first protrusion is formed from a first elastic material having a filler that is electrically conductive mixed therein, and
the second protrusion is formed from a second elastic material having a higher elastic modulus than the first elastic material.

15. The load sensor according to claim 14, wherein
the first elastic material is a silicone rubber, and
the second elastic material is a silicone rubber having a higher elastic modulus than the silicone rubber of the first elastic material.

16. The load sensor according to claim 14, wherein
the first elastic material having the filler mixed
therein has a standard hardness of 40 degrees or less, and the second elastic material has a standard hardness larger than 40 degrees.
